(19) United States
(12) Patent Application Publication
(10) Pub. No.: US 2026/0140724 A1
(43) Pub. Date: May 21, 2026

(54) APPARATUS, SYSTEM, AND METHOD OF COMPILING CODE FOR A PROCESSOR

(71) Applicant: MobilEye Vision Technologies Ltd., Jerusalem (IL)

(72) Inventors: Elena DEMIKHOVSKY, Haifa (IL); Dorit NUZMAN, Haifa (IL); Ziv BEN ZION, Mitzpe Aviv (IL); Ayal ZAKS, Timrat (IL); Ayman MOUSA, Haifa (IL)

(73) Assignee: MobilEye Vision Technologies Ltd., Jerusalem (IL)

(21) Appl. No.: 19/119,470

(22) PCT Filed: Oct. 12, 2023
(86) PCT No.: PCT/IB2023/060305

§ 371 Date: Apr. 9, 2025

Related U.S. Application Data
(60) Provisional application No. 63/415,307, filed on Oct. 12, 2022.

(51) Int. Cl. G06F 8/41

(52) U.S. Cl. CPC G06F 8/447

(57) ABSTRACT

For example, a compiler may be configured to identify a loop nest based on a source code, the loop nest including a plurality of loops, the plurality of loops including at least a first loop and second loop nested in the first loop, wherein the first loop includes at least one first-loop instruction which is outside the second loop, wherein the second loop includes one or more second-loop instructions; to transform the loop nest into a transformed loop, the transformed loop including a conditional instruction based on the first-loop instruction, the conditional instruction based on a state of a second-loop predicate, wherein the second-loop predicate is to identify a start of the second loop or an end of the second loop; and one or more transformed-loop instructions based on the one or more second-loop instructions; and to generate target code based on the transformed loop.

### CROSS REFERENCE

This application claims the benefit of and priority from U.S. Provisional Patent Application No. 63/415,307 entitled “APPARATUS, SYSTEM, AND METHOD OF COMPILING CODE FOR A PROCESSOR”, filed Oct. 12, 2022, the entire disclosure of which is incorporated herein by reference.

### BACKGROUND

A compiler may be configured to compile source code into target code configured for execution by a processor.

There is a need to provide a technical solution to support efficient processing functionalities.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a compiler, in accordance with some demonstrative aspects.

FIG. 3 is a schematic illustration of a vector processor, in accordance with some demonstrative aspects.

FIG. 4 is a schematic flow-chart illustration of a method of compiling code for a processor, in accordance with some demonstrative aspects.

FIG. 5 is a schematic flow-chart illustration of a method of compiling code for a processor, in accordance with some demonstrative aspects.

FIG. 6 is a schematic illustration of a product, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities capture the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects, for example, may capture the form of an entirely hardware aspect, an entirely software aspect, or an aspect including both hardware and software elements. Some aspects may be implemented in software, which includes but is not limited to firmware, resident software, microcode, or the like.

Furthermore, some aspects may capture the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some demonstrative aspects, the medium may be an electronic, magnetic, optical, electromagnetic, infrared, or semiconductor system (or apparatus or device) or a propagation medium.

In some demonstrative aspects, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some demonstrative aspects, input/output or I/O devices (including but not limited to keyboards, displays, pointing devices, etc.) may be coupled to the system either directly or through intervening I/O controllers. In some demonstrative aspects, network adapters may be coupled to the system to enable the data processing system to become coupled to other data processing systems or remote printers or storage devices, for example, through intervening private or public networks. In some demonstrative aspects, modems, cable modems and Ethernet cards are demonstrative examples of types of network adapters. Other suitable components may be used.

Some aspects may be used in conjunction with various devices and systems, for example, a computing device, a computer, a mobile computer, a non-mobile computer, a server computer, or the like.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., processor circuitry, control circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

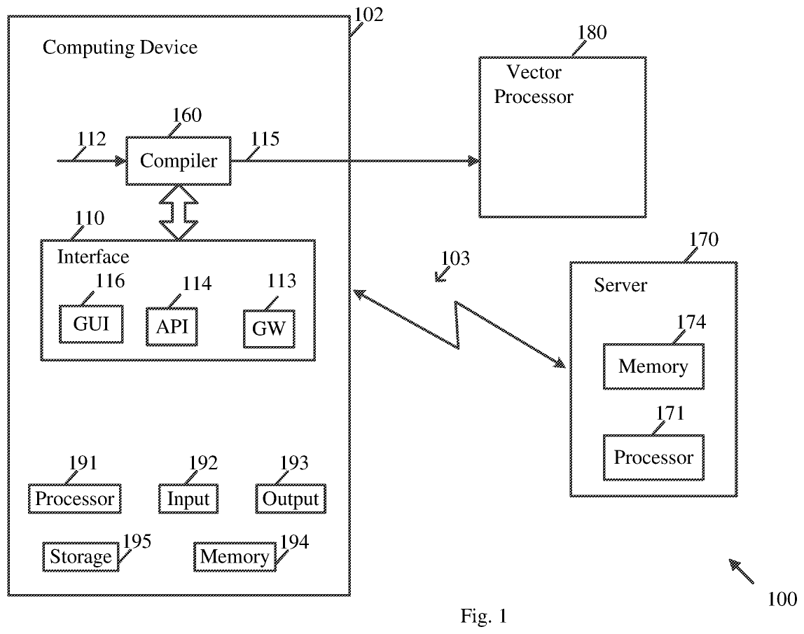

Reference is now made to FIG. 1, which schematically illustrates a block diagram of a system 100, in accordance with some demonstrative aspects.

As shown in FIG. 1, in some demonstrative aspects system 100 may include a computing device 102.

In some demonstrative aspects, device 102 may be implemented using suitable hardware components and/or software components, for example, processors, controllers, memory units, storage units, input units, output units, communication units, operating systems, applications, or the like.

In some demonstrative aspects, device 102 may include, for example, a computer, a mobile computing device, a non-mobile computing device, a laptop computer, a notebook computer, a tablet computer, a handheld computer, a Personal Computer (PC), or the like.

In some demonstrative aspects, device 102 may include, for example, one or more of a processor 191, an input unit 192, an output unit 193, a memory unit 194, and/or a storage unit 195. Device 102 may optionally include other suitable hardware components and/or software components. In some demonstrative aspects, some or all of the components of one or more of device 102 may be enclosed in a common housing or packaging, and may be interconnected or operably associated using one or more wired or wireless links. In other aspects, components of one or more of device 102 may be distributed among multiple or separate devices.

In some demonstrative aspects, processor 191 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications.

In some demonstrative aspects, input unit 192 may include, for example, a keyboard, a keypad, a mouse, a touch-screen, a touch-pad, a track-ball, a stylus, a microphone, or other suitable pointing device or input device. Output unit 193 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 may include, for example, a hard disk drive, a Solid State Drive (SSD), or other suitable removable or non-removable storage units. Memory unit 194 and/or storage unit 195, for example, may store data processed by device 102.

In some demonstrative aspects, device 102 may be configured to communicate with one or more other devices via at least one network 103, e.g., a wireless and/or wired network.

In some demonstrative aspects, network 103 may include a wired network, a local area network (LAN), a wireless network, a wireless LAN (WLAN) network, a radio network, a cellular network, a WiFi network, an IR network, a Bluetooth (BT) network, and the like.

In some demonstrative aspects, device 102 may be configured to perform and/or to execute one or more operations, modules, processes, procedures and/or the like, e.g., as described herein.

In some demonstrative aspects, device 102 may include a compiler 160, which may be configured to generate a target code 115, for example, based on a source code 112, e.g., as described below.

In some demonstrative aspects, compiler 160 may be configured to translate the source code 112 into the target code 115, e.g., as described below.

In some demonstrative aspects, compiler 160 may include, or may be implemented as, software, a software module, an application, a program, a subroutine, instructions, an instruction set, computing code, words, values, symbols, and/or the like.

In some demonstrative aspects, the source code 112 may include computer code written in a source language.

In some demonstrative aspects, the source language may include a programing language. For example, the source language may include a high-level programming language, for example, such as, C language, C++ language, and/or the like.

In some demonstrative aspects, the target code 115 may include computer code written in a target language.

In some demonstrative aspects, the target language may include a low-level language, for example, such as, assembly language, object code, machine code, or the like.

In some demonstrative aspects, the target code 115 may include one or more object files, e.g., which may create and/or form an executable program.

In some demonstrative aspects, the executable program may be configured to be executed on a target computer. For example, the target computer may include a specific computer hardware, a specific machine, and/or a specific operating system.

In some demonstrative aspects, the executable program may be configured to be executed on a processor 180, e.g., as described below.

In some demonstrative aspects, processor 180 may include a vector processor 180, e.g., as described below. In other aspects, processor 180 may include any other type of processor.

Some demonstrative aspects are described herein with respect to a compiler, e.g., compiler 160, configured to compile source code 112 into target code 115 configured to be executed by a vector processor 180, e.g., as described below. In other aspects, a compiler, e.g., compiler 160, configured to compile source code 112 into target code 115 configured to be executed by any other type of processor 180.

In some demonstrative aspects, processor 180 may be implemented as part of device 102.

In other aspects, processor 180 may be implemented as part of any other device, e.g., separate from device 102.

In some demonstrative aspects, vector processor 180 (also referred to as an “array processor”) may include a processor, which may be configured to process an entire vector in one instruction, e.g., as described below.

In other aspects, the executable program may be configured to be executed on any other additional or alternative type of processor.

In some demonstrative aspects, the vector processor 180 may be designed to support high-performance image and/or vector processing. For example, the vector processor 180 may be configured to processes 1/2/3/4D arrays of fixed point data and/or floating point arrays, e.g., very quickly and/or efficiently.

In some demonstrative aspects, the vector processor 180 may be configured to process arbitrary data, e.g., structures with pointers to structures. For example, the vector processor 180 may include a scalar processor to compute the non-vector data, for example, assuming the non-vector data is minimal.

In some demonstrative aspects, compiler 160 may be implemented as a local application to be executed by device 102. For example, memory unit 194 and/or storage unit 195 may store instructions resulting in compiler 160, and/or processor 191 may be configured to execute the instructions resulting in compiler 160 and/or to perform one or more calculations and/or processes of compiler 160, e.g., as described below.

In other aspects, compiler 160 may include a remote application to be executed by any suitable computing system, e.g., a server 170.

In some demonstrative aspects, server 170 may include at least a remote server, a web-based server, a cloud server, and/or any other server.

In some demonstrative aspects, the server 170 may include a suitable memory and/or storage unit 174 having stored thereon instructions resulting in compiler 160, and a suitable processor 171 to execute the instructions, e.g., as descried below.

In some demonstrative aspects, compiler 160 may include a combination of a remote application and a local application.

In one example, compiler 160 may be downloaded and/or received by the user of device 102 from another computing system, e.g., server 170, such that compiler 160 may be executed locally by users of device 102. For example, the instructions may be received and stored, e.g., temporarily, in a memory or any suitable short-term memory or buffer of device 102, e.g., prior to being executed by processor 191 of device 102.

In another example, compiler 160 may include a client-module to be executed locally by device 102, and a server module to be executed by server 170. For example, the client-module may include and/or may be implemented as a local application, a web application, a web site, a web client, e.g., a Hypertext Markup Language (HTML) web application, or the like.

For example, one or more first operations of compiler 160 may be performed locally, for example, by device 102, and/or one or more second operations of compiler 160 may be performed remotely, for example, by server 170.

In other aspects, compiler 160 may include, or may be implemented by, any other suitable computing arrangement and/or scheme.

In some demonstrative aspects, system 100 may include an interface 110, e.g., a user interface, to interface between a user of device 102 and one or more elements of system 100, e.g., compiler 160.

In some demonstrative aspects, interface 110 may be implemented using any suitable hardware components and/or software components, for example, processors, controllers, memory units, storage units, input units, output units, communication units, operating systems, and/or applications.

In some aspects, interface 110 may be implemented as part of any suitable module, system, device, or component of system 100.

In other aspects, interface 110 may be implemented as a separate element of system 100.

In some demonstrative aspects, interface 110 may be implemented as part of device 102. For example, interface 110 may be associated with and/or included as part of device 102.

In one example, interface 110 may be implemented, for example, as middleware, and/or as part of any suitable application of device 102. For example, interface 110 may be implemented as part of compiler 160 and/or as part of an OS of device 102.

In some demonstrative aspects, interface 110 may be implemented as part of server 170. For example, interface 110 may be associated with and/or included as part of server 170.

In one example, interface 110 may include, or may be part of a Web-based application, a web-site, a web-page, a plug-in, an ActiveX control, a rich content component, e.g., a Flash or Shockwave component, or the like.

In some demonstrative aspects, interface 110 may be associated with and/or may include, for example, a gateway (GW) 113 and/or an Application Programming Interface (API) 114, for example, to communicate information and/or communications between elements of system 100 and/or to one or more other, e.g., internal or external, parties, users, applications and/or systems.

In some aspects, interface 110 may include any suitable Graphic-User-Interface (GUI) 116 and/or any other suitable interface.

In some demonstrative aspects, interface 110 may be configured to receive the source code 112, for example, from a user of device 102, e.g., via GUI 116, and/or API 114.

In some demonstrative aspects, interface 110 may be configured to transfer the source code 112, for example, to compiler 160, for example, to generate the target code 115, e.g., as described below.

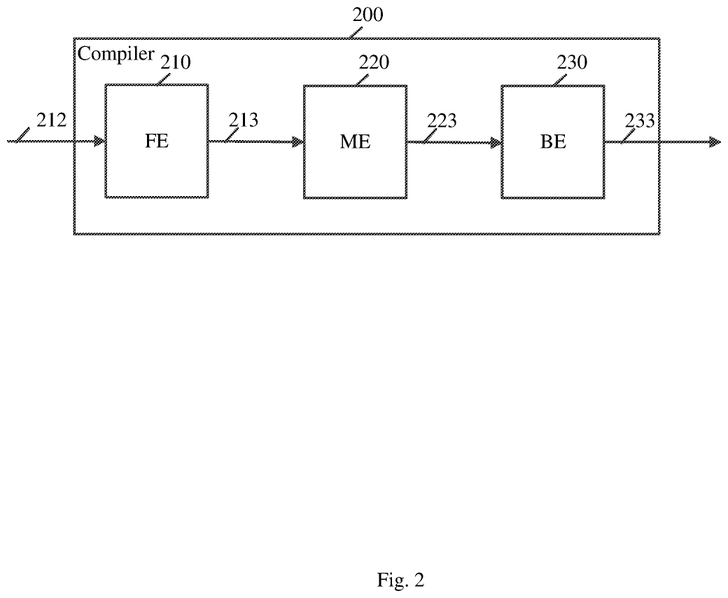

Reference is made to FIG. 2, which schematically illustrates a compiler 200, in accordance with some demonstrative aspects. For example, compiler 160 (FIG. 1) may be implement one or more elements of compiler 200, and/or may perform one or more operations and/or functionalities of compiler 200.

In some demonstrative aspects, as shown in FIG. 2, compiler 200 may be configured to generate a target code 233, for example, by compiling a source code 212 in a source language.

In some demonstrative aspects, as shown in FIG. 2, compiler 200 may include a front-end 210 configured to receive and analyze the source code 212 in the source language.

In some demonstrative aspects, front-end 210 may be configured to generate an intermediate code 213, for example, based on the source code 212.

In some demonstrative aspects, intermediate code 213 may include a lower level representation of the source code 212.

In some demonstrative aspects, front-end 210 may be configured to perform, for example, lexical analysis, syntax analysis, semantic analysis, and/or any other additional or alternative type of analysis, of the source code 212.

In some demonstrative aspects, front-end 210 may be configured to identify errors and/or problems with an outcome of the analysis of the source code 212. For example, front-end 210 may be configured to generate error information, e.g., including error and/or warning messages, for example, which may identify a location in the source code 212, for example, where an error or a problem is detected.

In some demonstrative aspects, as shown in FIG. 2, compiler 200 may include a middle-end 220 configured to receive and process the intermediate code 213, and to generate an adjusted, e.g., optimized, intermediate code 223.

In some demonstrative aspects, middle-end 220 may be configured to perform one or more adjustment, e.g., optimizations, to the intermediate code 213, for example, to generate the adjusted intermediate code 223.

In some demonstrative aspects, middle-end 220 may be configured to perform the one or more optimizations on the intermediate code 213, for example, independent of a type of the target computer to execute the target code 233.

In some demonstrative aspects, middle-end 220 may be implemented to support use of the optimized intermediate code 223, for example, for different machine types.

In some demonstrative aspects, middle-end 220 may be configured to optimize the intermediate representation of the intermediate code 223, for example, to improve performance and/or quality of the produced target code 233.

In some demonstrative aspects, the one or more optimizations of the intermediate code 213, may include, for example, inline expansion, dead-code elimination, constant propagation, loop transformation, parallelization, and/or the like.

In some demonstrative aspects, as shown in FIG. 2, compiler 200 may include a back-end 230 configured to receive and process the adjusted intermediate code 213, and to generate the target code 233 based on the adjusted intermediate code 213.

In some demonstrative aspects, back-end 230 may be configured to perform one or more operations and/or processes, which may be specific for the target computer to execute the target code 233. For example, back-end 230 may be configured to process the optimized intermediate code 213 by applying to the adjusted intermediate code 213 analysis, transformation, and/or optimization operations, which may be configured, for example, based on the target computer to execute the target code 233.

In some demonstrative aspects, the one or more analysis, transformation, and/or optimization operations applied to the adjusted intermediate code 213 may include, for example, resource and storage decisions, e.g., register allocation, instruction scheduling, and/or the like.

In some demonstrative aspects, the target code 233 may include target-dependent assembly code, which may be specific to the target computer and/or a target operating system of the target computer, which is to execute the target code 233.

In some demonstrative aspects, the target code 233 may include target-dependent assembly code for a processor, e.g., vector processor 180 (FIG. 1).

In some demonstrative aspects, compiler 200 may include a Vector Micro-Code Processor (VMP) Open Computing Language (OpenCL) compiler, e.g., as described below. In other aspects, compiler 200 may include, or may be implemented as part of, any other type of vector processor compiler.

In some demonstrative aspects, the VMP OpenCL compiler may include a Low Level Virtual Machine (LLVM) based (LLVM-based) compiler, which may be configured according to an LLVM-based compilation scheme, for example, to lower OpenCL C-code to VMP accelerator assembly code, e.g., suitable for execution by vector processor 180 (FIG. 1).

In some demonstrative aspects, compiler 200 may include one or more technologies, which may be required to compile code to a format suitable for a VMP architecture, e.g., in addition to open-sourced LLVM compiler passes.

In some demonstrative aspects, FE 210 may be configured to parse the OpenCL C-code and to translate it, e.g., through an Abstract Syntax Tree (AST), for example, into an LLVM Intermediate Representation (IR).

In some demonstrative aspects, compiler 200 may include a dedicated API, for example, to detect a correct pattern for compiler pattern matching, for example, suitable for the VMP. For example, the VMP may be configured as a Complex Instruction Set Computer (CISC) machine implementing a very complex Instruction Set Architecture (ISA), which may be hard to target from standard C code. Accordingly, compiler pattern matching may not be able to easily detect the correct pattern, and for this case the compiler may require a dedicated API.

In some demonstrative aspects, FE 210 may implement one or more vendor extension built-ins, which may target VMP-specific ISA, for example, in addition to standard OpenCL built-ins, which may be optimized to a VMP machine.

In some demonstrative aspects, FE 210 may be configured to implement OpenCL structures and/or work item functions.

In some demonstrative aspects, ME 220 may be configured to process LLVM IR code, which may be general and target-independent, for example, although it may include one or more hooks for specific target architectures.

In some demonstrative aspects, ME 220 may perform one or more custom passes, for example, to support the VMP architecture, e.g., as described below.

In some demonstrative aspects, ME 220 may be configured to perform one or more operations of a Control Flow Graph (CFG) Linearization analysis, e.g., as described below.

In some demonstrative aspects, the CFG Linearization analysis may be configured to linearize the code, for example, by converting if-statements to select patterns, for example, in case VMP vector code does not support standard control flow.

In one example, ME 220 may receive a given code, e.g., as follows:

```
If (x > 0) {
  A = A + 5;
} else {
  B = B * 2;
}
```

According to this example, ME 220 may be configured to apply the CFG Linearization analysis to the given code, e.g., as follows:

$$\begin{matrix}tmpA = A + 5 ; \\ tmpB = B * 2 ; \\ mask = x > 0 ; \\ A = Select mask , tmpA , A \\ B = Select mask , tmpB , B\end{matrix}$$

### Example (1)

In some demonstrative aspects, ME 220 may be configured to perform one or more operations of an auto-vectorization analysis, e.g., as described below.

In some demonstrative aspects, the auto-vectorization analysis may be configured to vectorize, e.g., auto-vectorize, a given code, e.g., to utilize vector capabilities of the VMP.

In some demonstrative aspects, ME 220 may be configured to perform the auto-vectorization analysis, for example, to vectorize code in a scalar form. For example, some or all operations of the auto-vectorization analysis may not be performed, for example, in case the code is already provided in a vectorized form.

In some demonstrative aspects, for example, in some use cases and/or scenarios, a compiler may not always be able to auto-vectorize a code, for example, due to data dependencies between loop iterations.

In one example, ME 220 may receive a given code, e.g., as follows:

char* a,b,c;
for (int i=0; i < 2048; i++) {
a[i]=b[i]+c[i];
}

According to this example, ME 220 may be configured to perform the CFG auto-vectorization analysis by applying a first conversion, e.g., as follows:

char* a,b,c;
for (int i=0; i < 2048; i+=32) {
a[i.i+31]=b[i...i+31]+c[i...i+31];
}

### Example (2a)

For example, ME 220 may be configured to perform the CFG auto-vectorization analysis by applying a second conversion, for example, following the first conversion, e.g., as follows:

char32* a,b,c;
for (int i=0; i < 64; i++) {
a[i]=b[i]+c[i];
}

### Example (2b)

In some demonstrative aspects, ME 220 may be configured to perform one or more operations of a Scratch Pad Memory Loop Access Analysis (SPMLAA), e.g., as described below.

In some demonstrative aspects, the SPMLAA may define Processing Blocks (PB), e.g., that should be outlined and compiled for VMP later.

In some demonstrative aspects, the processing blocks may include accelerated loops, which may be executed by the vector unit of the VMP.

In some demonstrative aspects, a PB, e.g., each PB, may include memory references. For example, some or all memory accesses may refer to local memory banks.

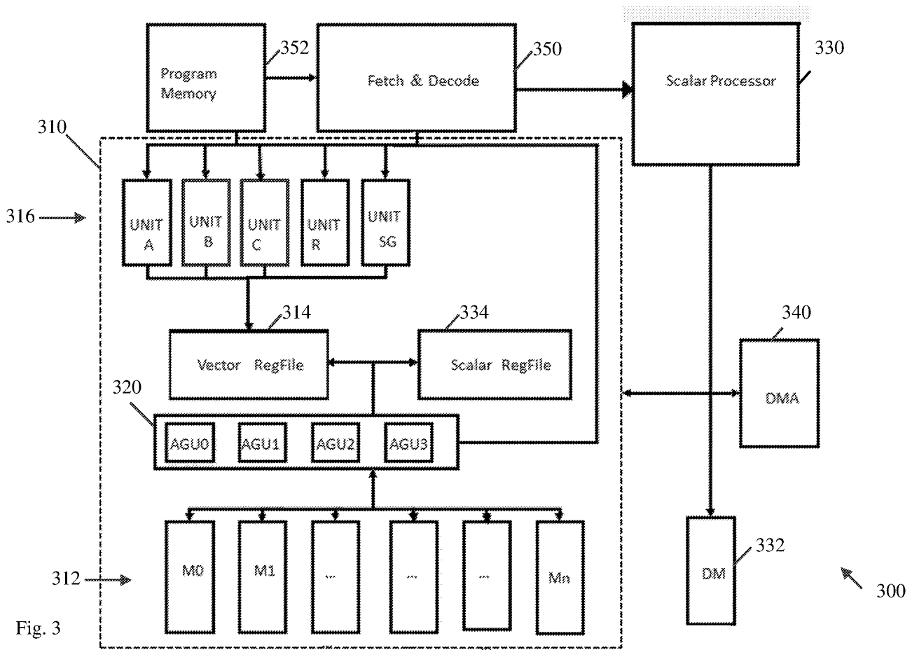

In some demonstrative aspects, the VMP may enable access to memory banks through AGUs, e.g., AGUs 320 as described below with reference to FIG. 3, and Scatter Gather units (SG).

In some demonstrative aspects, the AGUs may be pre-configured, e.g., before loop execution. For example, a loop trip count may be calculated, e.g., ahead of running a processing block.

In some demonstrative aspects, image references, e.g., some or all image references, may be created at this stage, and may be followed by calculation of strides and offsets, e.g., per dimension for each reference.

In some demonstrative aspects, ME 220 may be configured to perform one or more operations of an AGU planner analysis, e.g., as described below.

In some demonstrative aspects, the AGU Planner analysis may include iterator assignment, which may cover image references, e.g., all image references, from the entire Processing Block.

In some demonstrative aspects, an iterator may cover a single reference or a group of references.

In some demonstrative aspects, one or more memory references may be coalesced and/or reuse a same access through shuffle instructions, and/or saving values read from previous iterations.

In some demonstrative aspects, other memory references, e.g., which have no linear access pattern, may be handled using a Scatter-Gather (SG) unit, which may have a performance penalty, e.g., as it may require maintaining indices and/or masks.

In some demonstrative aspects, a plan may be configured as an arrangement of iterators in a processing block. For example, a processing block may have multiple plans, e.g., theoretically.

In some demonstrative aspects, the AGU Planner analysis may be configured to build all possible plans for all PBs, and to select a combination, e.g., a best combination, e.g., from all valid combinations.

In some demonstrative aspects, a total number of iterators in a valid combination may be limited, e.g., not to exceed a number of available AGUs on a VMP.

In some demonstrative aspects, one or more parameters, e.g., including stride, width and/or base, may be defined for an iterator, e.g., for each iterator for example, as part of the AGU Planner analysis. For example, min-max ranges for the iterators may be defined in a dimension, e.g., in each dimension, for example, as part of the AGU Planner analysis.

In some demonstrative aspects, the AGU Planner analysis may be configured to track and evaluate a memory reference, e.g., each memory reference, to an image, e.g., to understand its access pattern.

In one example, according to Examples 2a/2b, the image ‘a’ which is the base address, may be accessed with steps of 32 bytes for 64 iterations.

In some demonstrative aspects, the LLVM may include a scalar evaluation analysis (SCEV), which may compute an access pattern, e.g., to understand every image reference.

In some demonstrative aspects, ME 220 may utilize masking capabilities of the AGUs, for example, to avoid maintaining an induction variable, which may have a performance penalty.

In some demonstrative aspects, ME 220 may be configured to perform one or more operations of a rewrite analysis, e.g., as described below.

In some demonstrative aspects, the rewrite analysis may be configured to transform the code of a processing block, for example, while setting iterators and/or modifying memory access instructions.

In some demonstrative aspects, setting of the iterators, e.g., of all iterators, may be implemented in IR in target-specific intrinsics. For example, the setting of the iterators may reside in a pre-header of an outermost loop.

In some demonstrative aspects, the rewrite analysis may include loop-perfectization analysis, e.g., as described below.

In some demonstrative aspects, the code may be compiled with a target that substantially all calculations should be executed inside the innermost loop.

For example, the loop-perfectization analysis may hoist instructions, e.g., to move into a loop an operation performed after a last iteration of the loop.

For example, the loop-perfectization analysis may sink instructions, e.g., to move into a loop an operation performed before a first iteration of the loop.

For example, the loop-perfectization analysis may hoist instructions and/or sink instructions, for example, such that substantially all instructions are moved from outer loops to the innermost loops.

For example, the loop-perfectization analysis may be configured to provide a technical solution to support VMP iterators, e.g., to work on perfectly nested loops only.

For example, the loop-perfectization analysis may result in a situation where there are no instructions between the “for” statements that compose the loop, e.g., to support VMP iterators, which cannot emulate such cases.

In some demonstrative aspects, the loop-perfectization analysis may be configured to collapse a nested loop into a single collapsed loop.

In one example, ME 220 may receive a given code, e.g., as follows:

```
for (int i = 0; i < N; i++) {
  int sum = 0;
  for (int j = 0; j < M; j++)
  {
    sum += a[j + stride * i];
  }
      res[i] = sum;
}
```

According to this example, ME 220 may be configured to perform the loop-perfectization analysis to collapse the nested loop in the code to a single collapsed loop, e.g., as follows:

```
for (int k = 0; k < N * M; k++) {
  sum = (k % M == 0 ? 0 : sum);
  sum += a[k % M + stride * ( k / M )];
    res[k/M] = sum;
}
```

### Example (3)

In some demonstrative aspects, ME 220 may be configured to perform one or more operations of a Vector Loop Outlining analysis, e.g., as described below.

In some demonstrative aspects, the Vector Loop Outlining analysis may be configured to divide a code between a scalar subsystem and a vector subsystem, e.g., vector processing block 310 (FIG. 3) and scalar processor 330 (FIG. 3) as described below with reference to FIG. 3.

In some demonstrative aspects, the VMP accelerator may include the scalar and/or vector subsystems, e.g., as described below. For example, each of the subsystems may have different compute units/processors. Accordingly, a scalar code may be compiled on a scalar compiler, e.g., an SSC compiler, and/or an accelerated vector code may run on the VMP vector processor.

In some demonstrative aspects, the Vector Loop Outlining analysis may be configured to create a separate function for a loop body of the accelerated vector code. For example, these functions may be marked for the VMP and/or may continue to the VMP backend, for example, while the rest of the code may be compiled by the SSC compiler.

In some demonstrative aspects, one or more parts of a vector loop, e.g., configuration of the vector unit and/or initialization of vector registers, may be performed by a scalar unit. However, these parts may be performed in a later stage, for example, by performing backpatching into the scalar code, e.g., as the scalar code may still be in LLVM IR before processing by the SSC compiler.

In some demonstrative aspects, BE 230 may be configured to translate the LLVM IR into machine instructions. For example, the BE 230 may not be target agnostic and may be familiar with target-specific architecture and optimizations, e.g., compared to ME 220, which may be agnostic to a target-specific architecture.

In some demonstrative aspects, BE 230 may be configured to perform one or more analyses, which may be specific to a target machine, e.g., a VMP machine, to which the code is lowered, e.g., although BE 230 may use common LLVM.

In some demonstrative aspects, BE 230 may be configured to perform one or more operations of an instruction lowering analysis, e.g., as described below.

In some demonstrative aspects, the instruction lowering analysis may be configured to translate LLVM IR into target-specific instructions Machine IR (MIR), for example, by translating the LLVM IR into a Directed Acyclic Graph (DAG).

In some demonstrative aspects, the DAG may go through a legalization process of instructions, for example, based on the data types and/or VMP instructions, which may be supported by a VMP HW.

In some demonstrative aspects, the instruction lowering analysis may be configured to perform a process of pattern-matching, e.g., after the legalization process of instructions, for example, to lower a node, e.g., each node, in the DAG, for example, into a VMP-specific machine instruction.

In some demonstrative aspects, the instruction lowering analysis may be configured to generate the MIR, for example, after the process of pattern-matching.

In some demonstrative aspects, the instruction lowering analysis may be configured to lower the instruction according to machine Application Binary Interface (ABI) and/or calling conventions.

In some demonstrative aspects, BE 230 may be configured to perform one or more operations of a unit balancing analysis, e.g., as described below.

In some demonstrative aspects, the unit balancing analysis may be configured to balance instructions between VMP compute units, e.g., data processing units 316 (FIG. 3) as described below with reference to FIG. 3.

In some demonstrative aspects, the unit balancing analysis may be familiar with some or all available arithmetic transformations, and/or may perform transformations according to an optimal algorithm.

In some demonstrative aspects, BE 230 may be configured to perform one or more operations of a modulo scheduler (pipeliner) analysis, e.g., as described below.

In some demonstrative aspects, the pipeliner may be configured to schedule the instructions according to one or more constraints, e.g., data dependency, resource bottlenecks and/or any other constrains, for example, using Swing Modulo Scheduling (SMS) heuristics and/or any other additional and/or alternative heuristic.

In some demonstrative aspects, the pipeliner may be configured to schedule a set, e.g., an Initiation Interval (II), of Very Long Instruction Word (VLIW) instructions that the program will iterate on, e.g., during a steady state.

In some demonstrative aspects, a performance metric, which may be based on a number of cycles a typical loop may execute, may be measured, e.g., as follows:
(Size of Input data in bytes)*II/(Bytes consumed/produced every iteration)

In some demonstrative aspects, the pipeliner may try to minimize the II, e.g., as much as possible, for example, to improve performance.

In some demonstrative aspects, the pipeliner may be configured to calculate a minimum II, and to schedule accordingly. For example, if the pipeliner fails the scheduling, the pipeliner may try to increase the II and retry scheduling, e.g., until a predefined II threshold is violated.

In some demonstrative aspects, BE 230 may be configured to perform one or more operations of a register allocation analysis, e.g., as described below.

In some demonstrative aspects, the register allocation analysis may be configured to attempt to assign a register in an efficient, e.g., optimal, way.

In some demonstrative aspects, the register allocation analysis may assign values to bypass vector registers, general purpose vector registers, and/or scalar registers.

In some demonstrative aspects, the values may include private variables, constants, and/or values that are rotated across iterations.

In some demonstrative aspects, the register allocation analysis may implement an optimal heuristic that suites one or more VMP register file (regfile) constraints. For example, in some use cases, the register allocation analysis may not use a standard LLVM register allocation.

In some demonstrative aspects, in some cases, the register allocation analysis may fail, which may mean that the loop cannot be compiled. Accordingly, the register allocation analysis may implement a retry mechanism, which may go back to the modulo scheduler and may attempt to reschedule the loop, e.g., with an increased initiation interval. For example, increasing the initiation interval may reduce register pressure, and/or may support compilation of the vector loop, e.g., in many cases.

In some demonstrative aspects, BE 230 may be configured to perform one or more operations of an SSC configuration analysis, e.g., as described below.

In some demonstrative aspects, the SSC configuration analysis may be configured to set a configuration to execute the kernel, e.g., the AGU configuration.

In some demonstrative aspects, the SSC configuration analysis may be performed at a late stage, for example, due to configurations calculated after legalization, the register allocation analysis, and/or the modulo scheduling analysis.

In some demonstrative aspects, the SSC configuration analysis may include a Zero Overhead Loop (ZOL) mechanism in the vector loop. For example, the ZOL mechanism may configure a loop trip count based on an access pattern of the memory references in the loop, for example, to avoid running instructions that check the loop exit condition every iteration.

In some demonstrative aspects, a VMP Compilation Flow may include one or more, e.g., a few, steps, which may be invoked during the compilation flow in a test library (testlib), e.g., a wrapper script for compilation, execution, and/or program testing. For example, these steps may be performed outside of the LLVM Compiler.

In some demonstrative aspects, a PCB Hardware Description Language (PHDL) simulator may be implemented to perform one or more roles of an assembler, encoder, and/or linker.

In some demonstrative aspects, compiler 200 may be configured to provide a technical solution to support robustness, which may enable compilation of a vast selection of loops, with HW limitations. For example, compiler 200 may be configured to support a technical solution, which may not create verification errors.

In some demonstrative aspects, compiler 200 may be configured to provide a technical solution to support programmability, which may provide a user an ability to express code in multiple ways, which may compile correctly to the VMP architecture.

In some demonstrative aspects, compiler 200 may be configured to provide a technical solution to support an improved user-experience, which may allow the user capability to debug and/or profile code. For example, the improved user-experience may provide informative error messages, report tools, and/or a profiler.

In some demonstrative aspects, compiler 200 may be configured to provide a technical solution to support improved performance, for example, to optimize a VMP assembly code and/or iterator accesses, which may lead to a faster execution. For example, improved performance may be achieved through high utilization of the compute units and usage of its complex CISC.

Reference is made to FIG. 3, which schematically illustrates a vector processor 300, in accordance with some demonstrative aspects. For example, vector processor 180 (FIG. 1) may be implement one or more elements of vector processor 300, and/or may perform one or more operations and/or functionalities of vector processor 300.

In some demonstrative aspects, vector processor 300 may include a Vector Microcode Processor (VMP).

In some demonstrative aspects, vector processor 300 may include a Wide Vector machine, for example, supporting Very Long Instruction Word (VLIW) architectures, and/or Single Instruction/Multiple Data (SIMD) architectures.

In some demonstrative aspects, vector processor 300 may be configured to provide a technical solution to support high performance for short integral types, which may be common, for example, in computer-vision and/or deep-learning algorithms.

In other aspects, vector processor 300 may include any other type of vector processor, and/or may be configured to support any other additional or alternative functionalities.

In some demonstrative aspects, as shown in FIG. 3, vector processor 300 may include a vector processing block (vector processor) 310, a scalar processor 330, and a Direct Memory Access (DMA) 340, e.g., as described below.

In some demonstrative aspects, as shown in FIG. 3, vector processing block 310 may be configured to process, e.g., efficiently process, image data and/or vector data. For example, the vector processing block 310 may be configured to use vector computation units, for example, to speed up computations.

In some demonstrative aspects, scalar processor 330 may be configured to perform scalar computations. For example, the scalar processor 330 may be used as a “glue logic” for programs including vector computations. For example, some, e.g., even most, of the computation of the programs may be performed by the vector processing block 310. However, several tasks, for example, some essential tasks, e.g., scalar computations, may be performed by the scalar processor 330.

In some demonstrative aspects, the DMA 340 may be configured to interface with one or more memory elements in a chip including vector processor 300.

In some demonstrative aspects, the DMA 340 may be configured to read inputs from a main memory, and/or write outputs to the main memory.

In some demonstrative aspects, the scalar processor 330 and the vector processing block 310 may use respective local memories to process data.

In some demonstrative aspects, as shown in FIG. 3, vector processor 300 may include a fetcher and decoder 350, which may be configured to control the scalar processor 330 and/or the vector processing block 310.

In some demonstrative aspects, operations of the scalar processor 330 and/or the vector processing block 310 may be triggered by instructions stored in a program memory 352.

In some demonstrative aspects, the DMA 340 may be configured to transfer data, for example, in parallel with the execution of the program instructions in memory 352.

In some demonstrative aspects, DMA 340 may be controlled by software, e.g., via configuration registers, for example, rather than instructions, and, accordingly, may be considered as a second “thread” of execution in vector processor 300.

In some demonstrative aspects, the scalar processor 330, the vector processing block 310, and/or the DMA 340 may include one or more data processing units, for example, a set of data processing units, e.g., as described below.

In some demonstrative aspects, the data processing units may include hardware configured to preform computations, e.g., an Arithmetic Logic Unit (ALU).

In one example, a data processing unit may be configured to add numbers, and/or to store the numbers in a memory.

In some demonstrative aspects, the data processing units may be controlled by commands, e.g., encoded in the program memory 352 and/or in configuration registers. For example, the configuration registers may be memory mapped, and may be written by the memory store commands of the scalar processor 330.

In some demonstrative aspects, the scalar processor 330, the vector processing block 310, and/or the DMA 340 may include a state configuration including a set of registers and memories, e.g., as described below.

In some demonstrative aspects, as shown in FIG. 3, vector processor block 310 may include a set of vector memories 312, which may be configured, for example, to store data to be processed by vector processor block 310.

In some demonstrative aspects, as shown in FIG. 3, vector processor block 310 may include a set of vector registers 314, which may be configured, for example, to be used in data processing by vector processor block 310.

In some demonstrative aspects, the scalar processor 330, the vector processing block 310, and/or the DMA 340 may be associated with a set of memory maps.

In some demonstrative aspects, a memory map may include a set of addresses accessible by a data processing unit, which may load and/or store data from/to registers and memories.

In some demonstrative aspects, as shown in FIG. 3, the vector processing block 310 may include a plurality of Address Generation Units (AGUs) 320, which may include addresses accessible to them, e.g., in one or more of memories 312.

In some demonstrative aspects, as shown in FIG. 3, vector processor block 310 may include a plurality of data processing units 316, e.g., as described below.

In some demonstrative aspects, data processing units 316 may be configured to process commands, e.g., including several numbers at a time. In one example, a command may include 8 numbers. In another example, a command may include 4 numbers, 16 numbers, or any other count of numbers.

In some demonstrative aspects, two or more data processing units 316 may be used simultaneously. In one example, data processing units 316 may process and execute a plurality of different command, e.g., 3 different commands, for example, including 8 numbers, at a throughout of a single cycle.

In some demonstrative aspects, data processing units 316 may be asymmetrical. For example, first and second data processing units 316 may support different commands. For example, addition may be performed by a first data processing unit 316, and/or multiplication may be performed by a second data processing unit 316. For example, both operations may be performed by one or more additional other data processing units 316.

In some demonstrative aspects, data processing units 316 may be configured to support arithmetic operations for many combinations of input & output data types.

In some demonstrative aspects, data processing units 316 may be configured to support one or more operations, which may be less common. For example, processing units 316 may support operations working with a Look Up Table (LUT) of vector processor 300, and/or any other operations.

In some demonstrative aspects, data processing units 316 may be configured to support efficient computation of non-linear functions, histograms, and/or random data access, e.g., which may be useful to implement algorithms like image scaling, Hough transforms, and/or any other algorithms.

In some demonstrative aspects, vector memories 312 may include, for example, memory banks having a size of 16K or any other size, which may be accessed at a same cycle.

In one example, a maximal memory access size may be 64 bits. According to this example, a peak throughput may be 256 bits, e.g., 64×4=256. For example, high memory bandwidth may be implemented to utilize computation capabilities of the data processing units 316.

In one example, two data processing units 316 may support 16 8-bit multiply & accumulate operations (MACs) per cycle. According to this example, the two data processing units 316 may not be useful, for example, in case the input numbers are not fetched at this speed, and/or there isn't exactly 256 bits of input, e.g., 16×8×2=256.

In some demonstrative aspects, AGUs 320 may be configured to perform memory access operations, e.g., loading and storing data from/to vector memories 314.

In some demonstrative aspects, AGUs 320 may be configured to compute addresses of input and output data items, for example, to handle I/O to utilize the data processing units 316, e.g., in case sheer bandwidth is not enough.

In some demonstrative aspects, AGUs 320 may be configured to compute the addresses of the input and/or output data items, for example, based on configuration registers written by the scalar processor 330, for example, before a block of vector commands, e.g., a loop, is entered.

For example, AGUs 320 may be configured to write an image base pointer, a width, a height and/or a stride to the configuration registers, for example, in order to iterate over an image.

In some demonstrative aspects, AGUs 320 may be configured to handle addressing, e.g., all addressing, for example, to provide a technical solution in which data processing units 316 may not have the burden of incrementing pointers or counters in a loop, and/or the burden to check for end-of-row conditions, e.g., to zero a counter in the loop.

In some demonstrative aspects, as shown in FIG. 3, AGUs 320 may include 4 AGUs, and, accordingly, four memories 312 may be accessed at a same cycle. In other aspects, any other count of AGUs 32 may be implemented.

In some demonstrative aspects, AGUs 320 may not be “tied” to memory banks 312. For example, an AGU 320, e.g., each AGU 320, may access a memory bank 312, e.g., every memory bank 312, for example, as long as two or more AGUs 320 do not try to access the same memory bank 312 at the same cycle.

In some demonstrative aspects, vector registers 314 may be configured to support communication between the data processing units 316 and AGUs 320.

In one example, a total number of vector registers 314 may be 28, which may be divided into several subsets, e.g., based on their function. For example, a first subset of vector registers 314 may be used for inputs/outputs, e.g., of all data processing units 316 and/or AGUs 320; and/or a second subset of vector registers 314 may not be used for outputs of some operations, e.g., most operations, and may be used for one or more other operations, e.g., to store loop-invariant inputs.

In some demonstrative aspects, a data processing unit 316, e.g., each data processing unit 316, may have one or more registers to host an output of a last executed operation, e.g., which may be fed as inputs to other data processing units 316. For example, these registers may “bypass” the vector registers 314, and may work faster than writing these outputs to first set of vector registers 314.

In some demonstrative aspects, fetcher and decoder 350 may be configured to support low-overhead vector loops, e.g., very low overhead vector loops (also referred to as “zero-overhead vector loops”), for example, where there may be no need to check a termination (exit) condition of a vector loop during an execution of the vector loop.

For example, a termination (exit) condition may be signaled by an AGU 320, for example, when the AGU 320 finishes iterating over a configured memory region.

For example, fetcher and decoder 350 may quit the loop, for example, when the AGU 320 signals the termination condition.

For example, the scalar processor 330 may be utilized to configure the loop parameters, e.g., first & last instructions and/or the exit condition.

In one example, vector loops may be utilized, for example, together with high memory bandwidth and/or cheap addressing, for example, to solve a control and data flow problem, for example, to provide a technical solution to allow the data processing units 316 to process data, e.g., without substantially additional overhead.

In some demonstrative aspects, scalar processor 330 may be configured to provide one or more functionalities, which may be complementary to those of the vector processing block 310. For example, a large portion, e.g., most, of the work in a vector program may be performed by the data processing units 316. For example, the scalar processor 330 may be utilized, for example, for “gluing” together the various blocks of vector code of the vector program.

In some demonstrative aspects, scalar processor 330 may be implemented separately from vector processing block 310. In other aspects, scalar processor 330 may be configured to share one or more components and/or functionalities with vector processing block 310.

In some demonstrative aspects, scalar processor 330 may be configured to perform operations, which may not be suitable for execution on vector processing block 310.

For example, scalar processor 330 may be utilized to execute 32 bit C programs. For example, scalar processor 330 may be configured to support 1, 2, and/or 4 byte data types of C code, and/or some or all arithmetic operators of C code.

For example, scalar processor 330 may be configured to provide a technical solution to perform operations that cannot be executed on vector processing block 310, for example, without using a full-blown CPU.

In some demonstrative aspects, scalar processor 330 may include a scalar data memory 332, e.g., having a size of 16K or any other size, which may be configured to store data, e.g., variables used by the scalar parts of a program.

For example, scalar processor 330 may store local and/or global variables declared by portable C code, which may be allocated to scalar data memory by a compiler, e.g., compiler 200 (FIG. 2).

In some demonstrative aspects, as shown in FIG. 3, scalar processor 330 may include, or may be associated with, a set of vector registers 334, which may be used in data processing performed by the scalar processor 330.

In some demonstrative aspects, scalar processor 330 may be associated with a scalar memory map, which may support scalar processor 330 in accessing substantially all states of vector processor 300. For example, the scalar processor 330 may configure the vector units and/or the DMA channels via the scalar memory map.

In some demonstrative aspects, scalar processor 330 may not be allowed to access one or more block control registers, which may be used by external processors to run and debug vector programs.

In some demonstrative aspects, DMA 340 may be configured to communicate with one or more other components of a chip implementing the vector processor 300, for example, via main memory. For example, DMA 340 may be configured to transfer blocks of data, e.g., large, contiguous, blocks of data, for example, to support the scalar processor 330 and/or the vector processing block, which may manipulate data stored in the local memories. For example, a vector program may be able to read data from the main chip memory using DMA 340.

In some demonstrative aspects, DMA 340 may be configured to communicate with other elements of the chip, for example, via a plurality of DMA channels, e.g., 8 DMA channels or any other count of DMA channels. For example, a DMA channel, e.g., each DMA channel, may be capable of transferring a rectangular patch from the local memories to the main chip memory, or vice versa. In other aspects, the DMA channel may transfer any other type of data block between the local memories and the main chip memory.

In some demonstrative aspects, a rectangular patch may be defined by a base pointer, a width, a height, and astride.

For example, at peak throughput, 8 bytes per cycle may be transferred, however, there may be overheads for each patch and/or for each row in a patch.

In some demonstrative aspects, DMA 340 may be configured to transfer data, for example, in parallel with computations, e.g., via the plurality of DMA channels, for example, as long as executed commands do not access a local memory involved in the transfer.

In one example, as all channels may access the same memory bus, using several channels to implement a transfer may not save I/O cycles, e.g., compared to the case when a single channel is used. However, the plurality of DMA channels may be utilized to schedule several transfers and execute them in parallel with computations. This may be advantageous, for example, compared to a single channel, which may not allow scheduling a second transfer before completion of the first transfer.

In some demonstrative aspects, DMA 340 may be associated with a memory map, which may support the DMA channels in accessing vector memories and/or the scalar data. For example, access to the vector memories may be performed in parallel with computations. For example, access to the scalar data may usually not be allowed in parallel, e.g., as the scalar processor 330 may be involved in almost any sensible program, and may likely access it's local variables while the transfer is performed, which may lead to a memory contention with the active DMA channel.

In some demonstrative aspects, DMA 340 may be configured to provide a technical solution to support parallelization of I/O and computations. For example, a program performing computations may not have to wait for I/O, for example, in case these computations may run fast by vector processing block 310.

In some demonstrative aspects, an external processor, e.g., a CPU, may be configured to initiate execution of a program on vector processor 300. For example, vector processor 300 may remain idle, e.g., as long as program execution is not initiated.

In some demonstrative aspects, the external processor may be configured to debug the program, e.g., execute a single step at a time, halt when the program reaches breakpoints, and/or inspect contents of registers and memories storing the program variables.

In some demonstrative aspects, an external memory map may be implemented to support the external processor in controlling the vector processor 300 and/or debugging the program, for example, by writing to control registers of the vector processor 300.

In some demonstrative aspects, the external memory map may be implemented by a superset of the scalar memory map. For example, this implementation may make all registers and memories defined by the architecture of the vector processor 300 accessible to a debugger back-end running on the external processor.

In some demonstrative aspects, the vector processor 300 may raise an interrupt signal, for example, when the vector processor 300 terminates a program.

In some demonstrative aspects, the interrupt signal may be used, for example to implement a driver to maintain a queue of programs scheduled for execution by the vector processor 300, and/or to launch a new program, e.g., by the external processor, for example, upon the completion of a previously executed program.

Referring back to FIG. 1, in some demonstrative aspects, compiler 160 may be configured to generate the target code 115 based on one or more loops, which may be based, for example, on source code 112, e.g., as described below.

In some demonstrative aspects, compiler 160 may be configured to generate the target code 115 based on one or more loops, which may be configured, for example, according to a loop-execution scheme, e.g., as described below.

In some demonstrative aspects, the loop-execution scheme may be configured to provide a technical solution to support one or more vector processing architectures, for example, VLIW architectures and/or any other architectures, e.g., as described below.

In some demonstrative aspects, the loop-execution scheme may be configured to provide a technical solution to support improvement of one or more types of loop nests, for example, imperfect-loop-nests, e.g., as described below.

In some demonstrative aspects, a loop nest may include at least an outer loop and an inner loop, e.g., as described below.

In some demonstrative aspects, the loop nest may include an outer loop, e.g., a most outer loop, an inner loop, e.g., a most inner loop, and one or more nested loops (also referred to as “intermediate nested loops” or “intermediate loops”), which may be nested between the outer loop and the inner loop, e.g., as described below.

In some demonstrative aspects, the loop nest may include a plurality of loops nested in a plurality of nest levels, e.g., as described below.

In one example, the plurality of loops may include a first loop, e.g., an outer loop, for example, in a first nest level, and a second loop, e.g., an inner loop, for example, in a second nest level.

In one example, the plurality of loops may include one or more intermediate loops, for example, in one or more intermediate nest levels, e.g., between the first nest level and the second nest level.

In one example, the plurality of loops may include three loops in three nest levels. For example, the three loops may include a first loop, e.g., an outermost loop, at a first nest level; a second loop, e.g., an intermediate loop, at a second nest level; and a third loop, e.g., an innermost loop, at a third nest level. For example, the second loop may be nested in the first loop, and the third loop may be nested in the second loop.

In some demonstrative aspects, there may be a need to provide a technical solution to efficiently transform imperfect-loop-nests into perfect loop nests, for example, to improve performance of an executable program, for example, when executed by a processor, for example, a vector processor or any other target processor, e.g., as described below.

In some demonstrative aspects, a perfect loop-nest may be configured to include a loop nest, in which all compute operations of the loop-nest reside in an inner-most loop of the perfect loop-nest.

For example, outer-loops of the perfect loop-nest may not include any compute instructions.

For example, all the compute instructions of the perfect loop-nest may be in the most inner loop of the perfect loop-nest.

In one example, one or more processor architectures may require using prefect loop nests in a program and/or may benefit from using the prefect loop nests in the program.

In another example, the perfect loop-nests may be amenable to one or more, e.g., many more, loop-optimizations.

In another example, one or more scheduling schemes, e.g., modulo-scheduling, which may be critical optimization for VLIW targets, may not be able to optimize code across loop-levels/basic-blocks, for example, when perfect loop-nests are not used.

In another example, one or more processor architectures may support only the perfect loop nests. For example, these architectures may rely on being able to perfectize loop-nests into perfect loops.

In some demonstrative aspects, compiler 160 may be configured to generate the target code 115 based on one or more loops, which may be configured, for example, according to a loop-execution scheme, which may be configured to provide a technical solution to improve performance of a program executed by a target processor, for example, a vector processor, for example, by transforming imperfect-loop-nests into perfect loop nests, e.g., as described below.

In some demonstrative aspects, the loop-execution scheme may be configured to provide a technical solution to improve performance of a program executed by a target processor, for example, a vector processor, for example, by efficiently transforming imperfect-loop-nests into collapsed loops, e.g., as described below.

In some demonstrative aspects, a collapsed loop of a perfect loop nest may be configured to include a single-basic-block loop including all nested loops of the perfect loop, e.g., as described below.

In some demonstrative aspects, execution of the single-basic-block loop may be configured in advance, for example, along different dimensions, e.g., which may correspond to the original loops in the original loop nest.

For example, execution of the collapsed loop may be configured in advance, e.g., by control hardware (“HW controlled”), e.g., as described below.

In one example, one or more processor architectures may support only collapsed loops. For example, these processor architectures may rely on an ability to collapse and/or perfectize loop-nests into single-basic-block and/or perfect loops.

In some demonstrative aspects, compiler 160 may be configured to generate the target code 115 based on one or more loops, which may be configured, for example, according to a loop-execution scheme, which may be configured to provide a technical solution to support transformation of imperfect-loop-nests into perfect loop nests, for example, to improve performance of an executable program, e.g., as described below.

In some demonstrative aspects, the loop-execution scheme may be configured to provide a technical solution to efficiently transform imperfect-loop-nests into collapsed loops, for example, by transforming perfect loop nests into collapsed loops, e.g., as described below.

In some demonstrative aspects, compiler 160 may be configured to generate the target code 115 based on a compilation scheme, which may be configured, for example, to provide a technical solution to support computing one or mor predicates, which may be utilized for the transformation of imperfect-loop-nests into perfect loop nests and/or for the transformation of imperfect-loop-nests into collapsed loops, e.g., as described below.

In some demonstrative aspects, a predicate may be configured to indicate, identify, affirm, predict, and/or assert a start of a loop and/or an end of a loop, e.g., a first iteration or a last iteration of the loop.

In some demonstrative aspects, the predicate may be configured to identify the start of a loop and/or the end of a loop, for example, even without handling and/or maintaining an induction variable, e.g., as described below.

In one example, one or more predicates may be utilized to indicate a start and/or an end of execution of one or more inner-loops nested in an original loop nest, e.g., as described below.

In one example, it may be important to efficiently compute the predicates, for example, in cases where loop perfectization and/or loop collapsing rely on predication, e.g., as described below.

In another example, it may be important to efficiently compute the predicates, for example, to support processor architectures, which may not be able to efficiently compute induction-variables, e.g., as described below.

In some demonstrative aspects, the loop-execution scheme may be configured to provide a technical solution to support processor architectures, which may not support predicated instructions for non-memory-access operations.

In some demonstrative aspects, the loop-execution scheme may be configured to provide a technical solution to support computing predicates, for example, to support transformation of loop nests into perfect loop nests and/or collapsed loops, e.g., as described below.

In some demonstrative aspects, the loop-execution scheme may be configured to provide a technical solution to support executing programs more efficiently, for example, while avoiding a need to compute an induction-variable based predicate, e.g., as described below.

In some demonstrative aspects, the loop-execution scheme may be configured to provide a technical solution to support one or more architectures, which do not have predicated operations in hardware and/or have loop-nests controlled by hardware, e.g., as described below.

In some demonstrative aspects, compiler 160 may be configured to identify one or more loop nests based on source code, e.g., as described below.

In some demonstrative aspects, compiler 160 may be configured to identify the one or more of the loop nests in source code 112, e.g., in case the loop nests are included in source code 112.

In some demonstrative aspects, compiler 160 may be configured to identify the one or more of the loop nests in code, e.g., middle-end code, which may be compiled from the source code 112.

In some demonstrative aspects, compiler 160 may be configured to transform one or more identified loop nests into one or more perfect loop-nests, e.g., as described below.

In some demonstrative aspects, compiler 160 may be configured to compile the source code 112 into the target code 115, for example, such that target code 115 may be based on the one or more perfect loop-nests, e.g., as described below.

In some demonstrative aspects, compiler 160 may be configured to transform the one or more identified loop nests into the one or more perfect loop-nests, for example, according to a loop-perfectization scheme, e.g., as described below.

In some demonstrative aspects, compiler 160 may be configured to move one or more outer instructions from outer loop-levels of a loop nest into an inner loop, e.g., an innermost loop, of the loop nest, for example, while using one or more predicates to guard the execution of the outer instructions that were moved into the inner loop, e.g., as described below.

In some demonstrative aspects, the predicates may be configured to check and/or represent a state of an induction-variable, which counts a number of iterations of the inner-loop, e.g., as described below.

In some demonstrative aspects, a predicate (also referred to as a “loop-start predicate”) may be configured to identify when the induction-variable may be equal to the start of a respective inner-loop, e.g., for an instruction (also referred to as “sunk instruction”) moved from before the inner-loop into the inner-loop, e.g., as described below.

In some demonstrative aspects, a predicate (also referred to as a “loop-end predicate”) may be configured to identify when the induction-variable may be equal to the end of a respective inner-loop, e.g., for an instruction (also referred to as “hoist instruction”) moved from after the inner-loop into the inner-loop, e.g., as described below.

In some demonstrative aspects, compiler 160 may be configured to move all instructions from outer loop-levels (nest levels) of the loop nest into the innermost loop of the loop nest, for example, to transform the loop nest into a perfect loop nest, e.g., as described below.

In some demonstrative aspects, compiler 160 may be configured to identify one or more outer-loop instructions of an outer-loop of a loop nest, which is outer to an inner loop of the loop nest, e.g., as described below.

In some demonstrative aspects, compiler 160 may be configured to move an outer-loop instruction into the inner loop of the loop nest, for example, based on a location-based criterion relating to a location of the outer-loop instruction with respect to the inner loop, e.g., as described below.

In some demonstrative aspects, the location-based criterion may be used to identify whether the outer-loop instruction is before the inner loop (“a pre-header instruction”) or after the inner loop (“a latch instruction”), e.g., as described below.

In some demonstrative aspects, compiler 160 may be configured to transform an outer-loop instruction into a conditional instruction in the inner loop, which may be within the inner loop of the loop nest, e.g., as described below.

For example, the conditional instruction may be configured based on the location-based criterion, e.g., as described below.

In some demonstrative aspects, the conditional instruction may be configured, for example, based on a predicate to indicate, identify, affirm, predict, and/or assert a count of iterations of the inner loop, e.g., as described below.

In some demonstrative aspects, the conditional instruction may be configured as a conditional select operation, which may be based, for example, on the predicate on the count of iterations of the inner loop, e.g., as described below.

In some demonstrative aspects, the conditional instruction may be configured to select between two values, for example, based on the predicate on the count of iterations of the inner loop, e.g., as described below.

In some demonstrative aspects, the outer-loop instruction may include an operation on a variable, and the conditional instruction may be configured to select between two values for the variable, for example, based on the predicate on the count of iterations of the inner loop, e.g., as described below.

In some demonstrative aspects, the outer-loop instruction may include an operation on a variable, and the conditional instruction may be configured to select between two operations on the variable, for example, based on the predicate on the count of iterations of the inner loop, e.g., as described below.

In some demonstrative aspects, the predicate may be utilized to indicate, identify, affirm, predict, and/or assert whether the inner loop is at a first iteration of the inner loop or at a last iteration of the inner loop, e.g., as described below.

In some demonstrative aspects, compiler 160 may be configured to sink an instruction, for example, by moving into an inner loop an instruction to be performed before a first iteration of the inner loop, e.g., as described below.

In some demonstrative aspects, a pre-header instruction may be sunk, for example, by moving the pre-header instruction into the inner loop, and transforming the pre-header instruction into a pre-header conditional instruction, e.g., as described below.

In some demonstrative aspects, the pre-header conditional instruction may include a condition to configure a result of the pre-header conditional instruction based on a predicate, for example, on the inner loop, e.g., as described below.

In some demonstrative aspects, compiler 160 may generate the target code 115 based on compiled code, which may be configured to configure a particular result of the pre-header conditional instruction, for example, when the predicate identifies that execution of the inner loop is before the first iteration of the inner loop, e.g., as described below.

In some demonstrative aspects, compiler 160 may be configured to hoist an instruction, for example, by moving into an inner loop an instruction to be performed after a last iteration of the inner loop, e.g., as described below.

In some demonstrative aspects, a latch instruction may be hoisted, for example, by moving the latch instruction into the inner loop, and transforming the latch instruction into a latch conditional instruction, e.g., as described below.

In some demonstrative aspects, the latch conditional instruction may include a condition to configure a result of the latch conditional instruction based on a predicate, for example, on the inner loop, e.g., as described below.

In some demonstrative aspects, compiler 160 may generate the target code 115 based on compiled code, which may be configured to configure a particular result of the latch conditional instruction, for example, when the predicate identifies that execution of the inner loop is after the last iteration of the inner loop.

In some demonstrative aspects, compiler 160 may be configured to repeatedly and/or iteratively perform the hoist and/or sink operations, for example, to iterate over all instructions in the loop nest, for example, until substantially all instructions are moved from outer loops into the innermost loops, e.g., as described below.

For example, the loop-execution scheme may be configured to provide a technical solution to support VMP iterators to work on perfect loop nests only. For example, the loop-execution scheme may result in a situation where there are no instructions between two subsequent “for” statements that compose the loop, e.g., as described below.

In some demonstrative aspects, compiler 160 may be configured to compile source code 112 into target code 115, for example, by transforming one or more loop nests into collapsed loops, e.g., as described below.

In some demonstrative aspects, the one or more loop nests may be transformed into collapsed loops, for example, to provide a technical solution to improve performance of execution of a program by a target processor, for example, a vector processor and/or any other processor, e.g., as described below.

In some demonstrative aspects, compiler 160 may be configured to transform one or more identified loop nests into collapsed loops, for example, according to a loop-collapsing scheme, e.g., as described below.

In some demonstrative aspects, compiler 160 may be configured to apply the loop-collapsing scheme, for example, based on a result of the loop-perfectization scheme, as described below.

In some demonstrative aspects, compiler 160 may be configured to apply the loop-collapsing scheme, for example, even without performing the loop-perfectization scheme, for example, when the loop-perfectization scheme is unnecessary, e.g., when an input loop nest includes a perfect loop nest.

In one example, compiler 160 may be configured to apply the loop-collapsing scheme, for example, to provide target code 115 configured for execution by one or more processor architectures, which support only single-basic-block loops.

In some demonstrative aspects, compiler 160 may be configured to collapse a plurality of individual loops of a loop nest into a single loop, which may be configured, for example, to execute substantially all the iterations of the original loop nest, e.g., as described below.

In some demonstrative aspects, execution of the collapsed loop may be configured in advance, for example, to configure advancement along dimensions of the original loop.

In some demonstrative aspects, the loop-collapsing scheme may be configured to provide a technical solution to support execution of target code 115 by one or more processor architectures, including processor architectures in which computation of induction variables may be computationally expensive.

In some demonstrative aspects, compiler 160 may be configured to identify a perfect loop nest including a plurality of nested loops, for example, based on the source code 112, e.g., as described below.

In some demonstrative aspects, the plurality of nested loops may correspond to a respective plurality of dimensions, e.g., as described below.

In some demonstrative aspects, a dimension of a nested loop may be executed during a number of iterations of the nested loops, e.g., as described below.

In some demonstrative aspects, compiler 160 may be configured to configure a collapsed loop based on the loop nest, for example, by collapsing the plurality of loop nests into a single loop, for example, based on the plurality of dimensions, e.g., as described below.

In some demonstrative aspects, the collapsed loop may be configured based on computation of induction variables, for example, from the loop nest, e.g., as described below.

In some demonstrative aspects, the collapsed loop may be configured according to a predicate-computation mechanism, which may be configured to support computation of a start-of-loop predicate and/or an end-of-loop predicate, e.g., as described below.

In some demonstrative aspects, the predicate-computation mechanism may be configured to provide a technical solution to support computation of the start-of-loop predicate and/or the end-of-loop predicate, for example, even without computing the induction variables of one or more of the loops in the loop nest, e.g., as described below.

In some demonstrative aspects, the predicate-computation mechanism may be configured to provide a technical solution to support computation of the start-of-loop predicate and/or the end-of-loop predicate, for example, at processor architectures, which may not support computation of induction variables, and/or at processor architectures, in which it may be computationally expensive to compute induction variables, e.g., when loops are entirely configured in advance.

In some demonstrative aspects, the predicate-computation mechanism may include a mechanism (“hardware mask reset”), which may be configured to compute the start-of-loop predicate and/or the end-of-loop predicate, for example, based on a configuration of an AGU, e.g., as described below.

In some demonstrative aspects, the hardware mask reset may configure the AGU to set a mask to be true, for example, when a loop starts or ends, e.g., as described below.

In other aspects, the predicate-computation mechanism may be implemented using any other additional or alternative mechanism to compute the start-of-loop predicate and/or the end-of-loop predicate.

In some demonstrative aspects, compiler 160 may be configured to identify a loop nest based on source code 112, e.g., as described below.

In some demonstrative aspects, compiler 160 may be configured to identify the loop nest including, for example, a plurality of loops, for example, including at least a first loop and second loop nested in the first loop, e.g., as described below.

In some demonstrative aspects, the first loop may include at least one first-loop instruction, which is outside the second loop, and the second loop may include one or more second-loop instructions, e.g., as described below.

In some demonstrative aspects, compiler 160 may be configured to transform the loop nest into a transformed loop, e.g., as described below.

In some demonstrative aspects, the transformed loop may include a conditional instruction, which may be based, for example, on the first-loop instruction, e.g., as described below.

In some demonstrative aspects, the conditional instruction may be based, for example, on a state of a second-loop predicate, which may be configured, for example, to identify a start of the second loop or an end of the second loop, e.g., as described below.

In some demonstrative aspects, the transformed loop may include one or more transformed-loop instructions based on the one or more second-loop instructions, e.g., as described below.

In some demonstrative aspects, the one or more transformed-loop instructions may include at least one, e.g., some or all, of the one or more second-loop instructions, e.g., as described below.

In some demonstrative aspects, compiler 160 may be configured to generate target code 115 based, for example, on compilation of the source code 112, for example, such that the target code 115 may be based on the transformed loop, e.g., as described below.

In some demonstrative aspects, compiler 160 may be configured to generate the target code 115 configured, for example, for execution by a target vector processor, for example, a vector processor 180, e.g., as described below.

In some demonstrative aspects, compiler 160 may be configured to generate the target code 115 configured, for example, for execution by a Very Long Instruction Word (VLIW) Single Instruction/Multiple Data (SIMD) target processor, e.g., processor 180.

In other aspects, compiler 160 may be configured to generate the target code 115 configured, for example, for execution by any other suitable type of processor.

In some demonstrative aspects, compiler 160 may be configured to generate the target code 115, for example, based on the source code 112 including Open Computing Language (OpenCL) code.

In other aspects, compiler 160 may be configured to generate the target code 115, for example, based on the source code 112 including any other suitable type of code.

In some demonstrative aspects, compiler 160 may be configured to compile the source code 112 into the target code 115, for example, according to a Low Level Virtual Machine (LLVM) based (LLVM-based) compilation scheme.

In other aspects, compiler 160 may be configured to compile the source code 112 into the target code 115 according to any other suitable compilation scheme.

In some demonstrative aspects, compiler 160 may be configured to generate the target code 115 to include AGU instructions to configure an AGU of the target processor 180 to execute the target code 1115, e.g., as described below.

In some demonstrative aspects, compiler 160 may be configured to generate the AGU instructions configured to cause the AGU to set an AGU mask to be true based on the start of the second loop or the end of the second loop, e.g., as described below.

In some demonstrative aspects, compiler 160 may be configured to generate the conditional instruction to be based on the AGU mask, e.g., as described below.

In some demonstrative aspects, compiler 160 may be configured to generate the conditional instruction to include a select operation to select between a first value and a second value based, for example, on the state of the second-loop predicate, e.g., as described below.

In some demonstrative aspects, compiler 160 may be configured to identify that the first-loop instruction includes a first-loop operation on a variable, and to generate the conditional instruction including a select operation to select between a first operation on the variable and a second operation on the variable, e.g., as described below.

In some demonstrative aspects, the first operation on the variable may be based, for example, on the first-loop operation on the variable, e.g., as described below.

In some demonstrative aspects, the second operation on the variable may be based, for example, on a second-loop operation on the variable in the second loop, e.g., as described below.

In other aspects, compiler 160 may be configured to generate the conditional instruction to include any other suitable conditional instruction and/or operation.

In some demonstrative aspects, compiler 160 may be configured to generate the transformed loop including at least one second-loop predicate instruction, which may be configured to identify the state of the second-loop predicate, e.g., as described below.

In some demonstrative aspects, the second-loop predicate instruction may include, for example, an Induction Variable (IV) independent (IV-independent) instruction, which is independent of an IV of the second loop and an IV of the first loop, e.g., as described below.

In some demonstrative aspects, compiler 160 may be configured to generate the second-loop predicate instruction, which may be configured to retrieve the AGU mask, e.g., as described below.

In some demonstrative aspects, compiler 160 may configure the conditional instruction to be based on the retrieved AGU mask, e.g., as described below.

In some demonstrative aspects, compiler 160 may be configured to generate the at least one second-loop predicate instruction to include, for example, at least one IV based (IV-based) instruction, which may be based on an IV of the second loop, e.g., as described below.

In some demonstrative aspects, compiler 160 may be configured to generate the at least one IV-based instruction to be separate from the conditional instruction, e.g., as described below.

In some demonstrative aspects, compiler 160 may be configured to generate the conditional instruction to include the at least one IV-based instruction, e.g., as described below.

In some demonstrative aspects, compiler 160 may be configured to identify the plurality of loops including a third loop nested in the first loop, for example, such that the second loop is nested in the third loop, and the first-loop instruction is outside the third loop, e.g., as described below.

In some demonstrative aspects, compiler 160 may be configured to generate the conditional instruction to be based on the state of the second-loop predicate and on a state of a third-loop predicate, e.g., as described below.

In some demonstrative aspects, the third-loop predicate may be configured to identify a start of the third loop or an end of the third loop, e.g., as described below.

In some demonstrative aspects, compiler 160 may be configured to generate the transformed loop to include at least one third-loop predicate instruction, which may be configured to identify the state of the third-loop predicate, e.g., as described below.

In some demonstrative aspects, compiler 160 may be configured to identify that the third loop includes a third-loop instruction, which is outside the second loop, e.g., as described below.

In some demonstrative aspects, compiler 160 may be configured to generate the transformed loop to include another conditional instruction based on the third-loop instruction, e.g., as described below.

In some demonstrative aspects, the other conditional instruction may be based on a state of a particular predicate to identify the start of the second loop or the end of the second loop, e.g., as described below.

In some demonstrative aspects, compiler 160 may be configured to configure the second-loop predicate as the particular predicate, for example, based on a determination that the first-loop instruction and the third-loop instruction are either both pre-header instructions or both latch instructions relative to the second loop, e.g., as described below.

In some demonstrative aspects, compiler 160 may be configured to configure a first predicate of the second-loop predicate or the particular predicate as a loop-start predicate to identify the start of the second loop, and to configure a second predicate of the second-loop predicate or the particular predicate as a loop-end predicate to identify the end of the second loop, for example, based on a determination that a first instruction of the first-loop instruction or the third-loop instruction is a pre-header instruction relative to the second loop and that a second instruction of the first-loop instruction or the third-loop instruction is a latch instruction relative to the second loop, e.g., as described below.

In some demonstrative aspects, compiler 160 may be configured to identify that the plurality of loops of the loop nest are nested in a plurality of nest levels, e.g., as described below.

In some demonstrative aspects, the plurality of nest levels may include one or more intermediate nest levels between a first nest level including the first loop and a second nest level including the second loop, e.g., as described below.

In some demonstrative aspects, compiler 160 may be configured to generate the conditional instruction to be based on the state of the second-loop predicate and on states of one or more intermediate loop predicates corresponding to the one or more intermediate nest levels, respectively, e.g., as described below.

In some demonstrative aspects, the second nest level may be an innermost nest level of the plurality of nest levels, e.g., as described below.

In some demonstrative aspects, compiler 160 may be configured to identify that the at least one first-loop instruction includes a pre-header instruction to be performed before a first iteration of the second loop, e.g., as described below.

In some demonstrative aspects, compiler 160 may be configured to configure the second-loop predicate to include a loop-start predicate, which is to identify the start of the second loop, e.g., as described below.

In some demonstrative aspects, compiler 160 may be configured to configure the conditional instruction, which is based on the pre-header instruction, to be before all of the one or more transformed-loop instructions based on the one or more second-loop instructions, e.g., as described below.

In some demonstrative aspects, compiler 160 may be configured to identify that the at least one first-loop instruction includes a latch instruction to be performed after a last iteration of the second loop, e.g., as described below.

In some demonstrative aspects, compiler 160 may be configured to configure the second-loop predicate to include a loop-end predicate, which is to identify the end of the second loop, e.g., as described below.

In some demonstrative aspects, compiler 160 may be configured to configure the conditional instruction, which is based on the latch instruction, to be after all of the one or more transformed-loop instructions based on the one or more second-loop instructions, e.g., as described below.

In some demonstrative aspects, compiler 160 may be configured to generate the transformed loop including a perfect flat loop, in which all compute operations of the loop nest are implemented in an inner-most loop, e.g., as described below.

In some demonstrative aspects, compiler 160 may be configured to generate the transformed loop including a fully collapsed loop comprising only a single-basic-block loop based on the plurality of loops, e.g., as described below.

In some demonstrative aspects, compiler 160 may compile a source code 112 of a program to be executed by a target processor, e.g., processor 180, as described below.

For example, complier 160 may identify based on source code 112 a loop nest including an outer loop along a dimension based on a value half_height, and an inner loop along a dimension based on a value half_width, e.g., as follows:

```
for(y = 1; y < 2 * half_height + 1; y += 2) {
  unsigned short left = 0;
  for(int xx = 0; xx < half_width; xx++) {
    x = 2*xx;
    unsigned short vr = raw[(x+1) + (y) * raw_stride];
    unsigned short right= compute(vr, linearize_LUT);
    unsigned short c = (left + right) / 2;
    left = right;
    tmpC[(x >> 1) + (y >> 1) * tmpC_stride] = c;
  }
}
```

### Example (4)

For example, as shown by Example 4, the outer loop may include a pre-header instruction, e.g., unsigned short left=0, which may reside before the header of the inner loop.

For example, as shown by Example 4, the pre-header instruction may be executed every time before execution of the inner loop begins.

In some demonstrative aspects, compiler 160 may be configured to sink the prereader instruction into the inner loop, for example, to generate a perfect loop nest, e.g., as described below.

For example, compiler 160 may be configured to move the pre-header instruction into the inner loop, and to transform the pre-header instruction into a conditional pre-header instruction, e.g., as follows:

```
for(y = 1; y < 2 * half_height + 1; y += 2) {
  for(int xx = 0; xx < half_width; xx++) {
    predicate = (is this the start of xx loop?) // (xx == 0);
    unsigned short left = predicate ? 0 : right
    unsigned short vr = read_next_element(raw);
    unsigned short right= compute(vr, linearize_LUT);
    unsigned short c = (left + right) / 2;
    write_next_element(tmp, c);
  }
}
```

### Example (5)

In some demonstrative aspects, as shown by Example 5, the pre-header instruction (unsigned short left=0) may be transformed into the conditional pre-header instruction (unsigned short left=predicate?0:right).

In some demonstrative aspects, as shown by Example 5, the conditional pre-header instruction may be based on a predicate, which may indicate, identify, affirm, predict, and/or assert a start of the inner-loop.

In some demonstrative aspects, as shown by Example 5, the conditional pre-header instruction may be configured such that a result of the conditional pre-header instruction may be equivalent to execution of the pre-header instruction (unsigned short left=0), for example, only when the predicate “xx==0?” is true, e.g., only when the inner loop starts to execute.

In some demonstrative aspects, compiler 160 may be configured to generate the target code 115 based on the perfect loop nest of Example 5.

In some demonstrative aspects, compiler 160 may be configured to transform the perfect loop nest of Example 5, for example, into a collapsed loop along a dimension, which may be based, for example, on the value half_height, and the value half_width, e.g., as follows:

```
CollaspedFor (half_height * half_width) {
  predicate = (is this the start of xx loop?)
  unsigned short left = predicate ? 0 : right
  unsigned short vr = read_next_elemenbt(raw);
  unsigned short right= compute(vr, linearize_LUT);
  unsigned short c = (left + right) / 2;
  write_next_element(tmp, c);
}
```

### Example (6)

In some demonstrative aspects, as shown by Example 6, the collapsed loop may include a single block, which may be executed, for example, according to the perfect loop nest of Example 5.

In some demonstrative aspects, as shown by Example 6, the collapsed loop may include the conditional pre-header instruction (unsigned short left=predicate?0:right), which may be based on the predicate.

In some demonstrative aspects, the induction variables “y” and “xx” of the loops of Example 5 may not be explicitly computed in the collapsed loop of Example 6, e.g., as the collapsed loop may not include any inner-loops to advance each of the individual induction variables “y” and “xx”.

In some demonstrative aspects, compiler 160 may be configured to generate the collapsed loop of Example 6, for example, in a manner, which may support computation of the predicate (predicate=(is this the start of xx loop?)), e.g., as follows:

```
Counter = 0;
CollapsedFor (half_height * half_width) {
  xx = Counter % half_width;
  y = Counter / half_height;
  predicate = (xx == 0);
  unsigned short left = predicate ? 0 : right
  unsigned short vr = read_next_elemenbt(raw);
  unsigned short right= compute(vr, linearize_LUT);
  unsigned short c = (left + right) / 2;
  write_next_element(tmp, c);
  Counter++;
}
```

### Example (7)

In some demonstrative aspects, as shown by Example 7, the collapsed loop may compute the predicate (predicate=(is this the start of xx loop?)), for example, based on the induction variables “y” and “xx”.

In some demonstrative aspects, compiler 160 may be configured to generate the collapsed loop of Example 6, for example, in a manner which may support computation of the predicate (predicate=(is this the start of xx loop?)), e.g., as follows:

```
y=0; xx = 0;
CollapsedFor (half_height * half_width) {
  predicate = (xx == 0);
  unsigned short left = predicate ? 0 : right
  unsigned short vr = read_next_elemenbt(raw);
  unsigned short right= compute(vr, linearize_LUT);
  unsigned short c = (left + right) / 2;
  write_next_element(tmp, c);
  y = (xx == half_width−1 ? y+1 : y);
  xx = (xx == half_width−1 ? 0 : xx+1);
}
```

### Example (8)

In some demonstrative aspects, as shown by Example 8, the collapsed loop may compute the predicate (predicate=(is this the start of xx loop?)), for example, based on the induction variables “y” and “xx”.

In some demonstrative aspects, compiler 160 may be configured to generate the collapsed loop of Example 6, for example, in a manner, which may support computation of the predicate, for example, even without relying on the induction variables “y” and “xx”, e.g., as described below.

In some demonstrative aspects, compiler 160 may be configured to generate the collapsed loop of Example 6 based on a predicate-computation mechanism, which may be configured to support computation of a start-of-loop predicate and/or an end-of-loop predicate, for example, even without maintaining and/or computing the induction variables “y” and/or “xx”, e.g., as described below.

In some demonstrative aspects, compiler 160 may be configured to generate the collapsed loop of Example 6, for example, based on a hardware mask reset mechanism, which may be configured to compute the start-of-loop predicate and/or the end-of-loop predicate, for example, based on a configuration of an AGU of the target processor 180, e.g., as described below.

In some demonstrative aspects, compiler 160 may be configured to generate the collapsed loop of Example 6, for example, by configuring the AGU of the target processor 180, e.g., before the loop, for example, such that the AGU is to set a mask that is true, for example, when the loop starts or ends, e.g., as described below.

In some demonstrative aspects, compiler 160 may generate the target code 115 to include AGU instructions to configure the AGU of the target processor 180, e.g., before execution of the loop, e.g., as described below.

In some demonstrative aspects, compiler 160 may generate the AGU instructions to configure the AGU to set the mask to be true, for example, when the loop starts or ends, e.g., in each iteration of each of the loops in the loop-nest.

For example, compiler 160 may be configured to generate that target code 115 based on the collapsed loop of Example 6, for example, by configuring the target code 115 to include AGU instructions to be executed by the AGU of the target processor 180, e.g., as follows:

```
AGU0 = init_agu( );
Set_agu_start_and_end_for_dim(0/*dimension of loop xx*/, 0/*start*/,
half_width/*end*/);
Set_agu_start_and_end_for_dim(1 /*dimension of loop y*/, 0/*start*/,
half_height/*end*/);
CollapsedFor (half_height * half_width) {
  // get the value of the mask register that holds the result of
  // (xx == 0) as set by AGU0 in each iteration of the loop.
  predicate = get_mask_from_agu (0 /*AGU*/, 0 /*dim*/, start);
  unsigned short left = predicate ? 0 : right
  unsigned short vr = read_next_elemenbt(raw);
  unsigned short right= compute(vr, linearize_LUT);
  unsigned short c = (left + right) / 2;
  write_next_element(tmp, c);
}
```

### Example (9)

For example, according to Example 9, a first dimension (dimension “0”) of the AGU may be set, for example, based on the induction variable “xx”.

For example, according to Example 9, a second dimension (dimension “1”) of the AGU may be set, for example, based on the induction variable “y”.

For example, according to Example 9, the AGU may be used to compute the start-of-loop predicate for xx=0.

For example, according to Example 9, the AGU instructions may be configured to set the first dimension (dimension 0) of the AGU to start from a value, e.g., 0, which may be based on a start value of the loop over the variable “xx”, and to end at a value, e.g., half_width, which may be based on an end value of the loop over the variable “xx”

In some demonstrative aspects, compiler 160 may compile a source code 112 of a program to be executed by a target processor, e.g., processor 180, as described below.

For example, complier 160 may identify, e.g., based on source code 112, a loop nest including an outer loop along a dimension based on a value zcount, an intermediate (nested) loop along a dimension based on a value ycount, and an inner loop along a dimension based on a variable xcount, e.g., as follows:

```
Sum = 0;
for(z = 0; z < zcount; z++) {
  unsigned short left = 0;
  for(y = 0; y < ycount; y ++) {
    for(int xx = 0; xx < xcount; xx++) {
      x = 2*xx;
      unsigned short vr = raw[(x+1) + (y) * raw_stride];
      unsigned short right= compute(vr, linearize_LUT);
      unsigned short c = (left + right) / 2;
      left = right;
      tmpC[(x >> 1) + (y >> 1) * tmpC_stride] = c;
    }
  }
  Sum++;
}
```

### Example (10)

In some demonstrative aspects, compiler 160 may be configured to transform the loop nest of Example 10 into a perfect loop nest, for example, be performing a plurality of operations, e.g., according to a loop-perfectization scheme, e.g., as described below.

In some demonstrative aspects, compiler 160 may be configured perform a first operation to sink outer instructions from an outer loop, e.g., an outer-most loop, into an inner loop having a loop level, which is one level below the loop level of the outer loop, e.g., as described below.

In some demonstrative aspects, compiler 160 may be configured perform additional subsequent operations, for example, where each subsequent operation may be configured to sink outer instructions from the inner loop to a next inner loop having a loop level, which is one level below the loop level of the inner loop, e.g., as described below.

In some demonstrative aspects, compiler 160 may be configured perform additional subsequent operations, for example, until reaching the inner-most loop level, e.g., as described below.

In some demonstrative aspects, as shown by Example 10, the loop nest may include a first pre-header instruction, e.g., Sum=0, which may be before the header of the outer loop.

In some demonstrative aspects, as shown by Example 10, the first pre-header instruction may be executed, for example, before a first iteration of the outer loop.

In some demonstrative aspects, compiler 160 may be configured to sink the first preheader instruction into the outer loop, for example, by moving the first pre-header instruction into the outer loop, and transforming the first pre-header instruction into a conditional pre-header instruction, e.g., as follows:

```
for(z = 0; z < zcount; z++) {
  Sum = (z == 0 ? 0 : Sum)
  unsigned short left = 0;
  for(y = 0; y < ycount; y ++) {
    for(int xx = 0; xx < xcount; xx++) {
      x = 2*xx;
      unsigned short vr = raw[(x+1) + (y) * raw_stride];
      unsigned short right= compute(vr, linearize_LUT);
      unsigned short c = (left + right) / 2;
      left = right;
      tmpC[(x >> 1) + (y >> 1) * tmpC_stride] = c;
    }
  }
  Sum++;
}
```

### Example (11)

In some demonstrative aspects, as shown by Example 11, the first pre-header instruction sum=0 may be transformed into a conditional pre-header instruction Sum=(z==0?0:Sum), which may be based on a predicate z==0, which may be configured to indicate, identify, affirm, predict, and/or assert the first iteration of the outer loop.

In some demonstrative aspects, as shown by Example 11, the outer loop may include two pre-header instructions, e.g., the conditional pre-header instruction Sum=(z==0?0:Sum), and a second pre-header instruction, e.g., unsigned short left=0, which may be located before the header of the nested loop.

In some demonstrative aspects, as shown by Example 11, the outer loop may include a latch instruction e.g., Sum++, which may be after the nested loop.

In some demonstrative aspects, compiler 160 may be configured to sink the two pre-header instructions into the nested loop, for example, by moving the two pre-header instructions into the nested loop, and transforming the two pre-header instructions into two respective conditional pre-header instructions, e.g., as described below.

In some demonstrative aspects, compiler 160 may be configured to hoist the latch instruction into the nested loop, for example, by moving the latch instruction into the nested loop, and transforming the latch instruction into conditional latch instruction.

For example, compiler 160 may be configured to sink the two pre-header instructions into the nested loop and to hoist the latch instruction into the nested loop, e.g., as follows:

```
for(z = 0; z < zcount; z++) {
  for(y = 0; y < ycount; y ++) {
    Sum = (z == 0 && y == 0 ? 0 : Sum );
    left = (y == 0 ? 0 : right);
    for(int xx = 0; xx < xcount; xx++) {
      x = 2*xx;
      unsigned short vr = raw[(x+1) + (y) * raw_stride];
      unsigned short right= compute(vr, linearize_LUT);
      unsigned short c = (left + right) / 2;
      tmpC[(x >> 1) + (y >> 1) * tmpC_stride] = c;
    }
    Sum = (y == ycount − 1 ? Sum + 1 : Sum );
  }
}
```

### Example (12)

In some demonstrative aspects, as shown by Example 12, the conditional pre-header instruction Sum=(z==0?0:Sum) may be transformed into a conditional pre-header instruction Sum=(z==0 && y==0?0:Sum), based on the predicate z==0, which may be configured to indicate, identify, affirm, predict, and/or assert the first iteration of the outer loop, and the predicate y==0, which may be configured to indicate, identify, affirm, predict, and/or assert the first iteration of the nested loop.

In some demonstrative aspects, as shown by Example 12, the second pre-header instruction unsigned short left=0 may be transformed into a conditional pre-header instruction left=(y==0?0:right), based on the predicate y==0, which may be configured to indicate, identify, affirm, predict, and/or assert the first iteration of the nested loop.

In some demonstrative aspects, as shown by Example 12, the latch instruction Sum++, may be transformed into a conditional latch instruction, e.g., Sum=(y==ycount−1?Sum+1:Sum), based on the predicate y==ycount, which may be configured to indicate, identify, affirm, predict, and/or assert the last iteration of the nested loop.

In some demonstrative aspects, as shown by Example 12, the nested loop may include three outer instructions with respect to the inner-loop, e.g., including two pre-header instructions and a latch instruction.

For example, the two pre-header instructions may include the conditional pre-header instruction Sum=(z==0 & & y==0?0:Sum), the conditional pre-header instruction left=(y==0?0:right).

For example, the latch instruction may include the conditional latch instruction Sum=(y==ycount−1?Sum+1:Sum).

In some demonstrative aspects, compiler 160 may be configured to sink the two pre-header instructions into the inner loop, for example, by moving the two pre-header instructions in the inner loop, and transforming the two pre-header instructions into two conditional pre-header instructions, respectively.

In some demonstrative aspects, compiler 160 may be configured to hoist the latch instruction into the inner loop, for example, by moving the latch instruction into the inner loop, and transforming the latch instruction into a conditional latch instruction.

For example, compiler 160 may be configured to sink the two pre-header instructions into the inner loop, and to hoist the latch instruction into the inner loop, e.g., as follows:

```
for(z = 0; z < zcount; z++) {
  for(y = 0; y < ycount; y ++) {
    for(int xx = 0; xx < xcount; xx++) {
    Sum = (z == 0 && y == 0 && xx == 0 ? 0 : Sum );
    left = (y == 0 && xx == 0 ? 0 : right);
    x = 2*xx;
    unsigned short vr = raw[(x+1) + (y) * raw_stride];
    unsigned short right= compute(vr, linearize_LUT);
    unsigned short c = (left + right) / 2;
    tmpC[(x >> 1) + (y >> 1) * tmpC_stride] = c;
    Sum = ( y == ycount − 1 && xx == xcount − 1 ? Sum + 1 : Sum );
    }
  }
}
```

### Example (13)

In some demonstrative aspects, as shown by Example 13, the conditional pre-header instruction Sum=(z==0 && y==0?0:Sum) may be transformed into a conditional pre-header instruction, e.g., Sum=(z==0 && y==0 & & xx==0?0:Sum), based on the predicate z==0, which may be configured to indicate, identify, affirm, predict, and/or assert the first iteration of the outer loop; the predicate y==0, which may be configured to indicate, identify, affirm, predict, and/or assert the first iteration of the nested loop; and a predicate xx==0, which may be configured to indicate, identify, affirm, predict, and/or assert the first iteration of the inner loop.

In some demonstrative aspects, as shown by Example 13, the conditional pre-header instruction left=(y==0?0:right) may be transformed into a conditional pre-header instruction, e.g., left=(y==0 && xx==0?0:right), based on the predicate y==0, which may be configured to indicate, identify, affirm, predict, and/or assert the first iteration of the nested loop; and the predicate xx==0, which may be configured to indicate, identify, affirm, predict, and/or assert the first iteration of the inner loop.

In some demonstrative aspects, as shown by Example 13, the conditional latch instruction Sum=(y==ycount−1?Sum+1:Sum), may be transformed into a conditional latch instruction, e.g., Sum=(y==ycount−1&& xx==xcount−1?Sum+1:Sum), for example, based on the predicate y==ycount−1, which may be configured to indicate, identify, affirm, predict, and/or assert the last iteration of the nested loop; and the predicate xx==xcount−1, which may be configured to indicate, identify, affirm, predict, and/or assert the last iteration of the inner loop.

In some demonstrative aspects, as shown by Example 13, the loop nest may be transformed into a perfect loop nest, for example, as all instructions may be performed in the inner-most loop of the loop nest, e.g., after the “for statement” of the inner loop.

In some demonstrative aspects, compiler 160 may be configured to generate the target code 115, for example, based on the code of Example 13.

In some demonstrative aspects, compiler 160 may be configured to collapse the perfect loop nest of Example 13 into a collapsed loop, for example, according to a loop-collapsing scheme, e.g., as described above.

In some demonstrative aspects, compiler 160 may be configured to generate the target code 115, for example, based on the collapsed loop, which may be based on the code of Example 13.

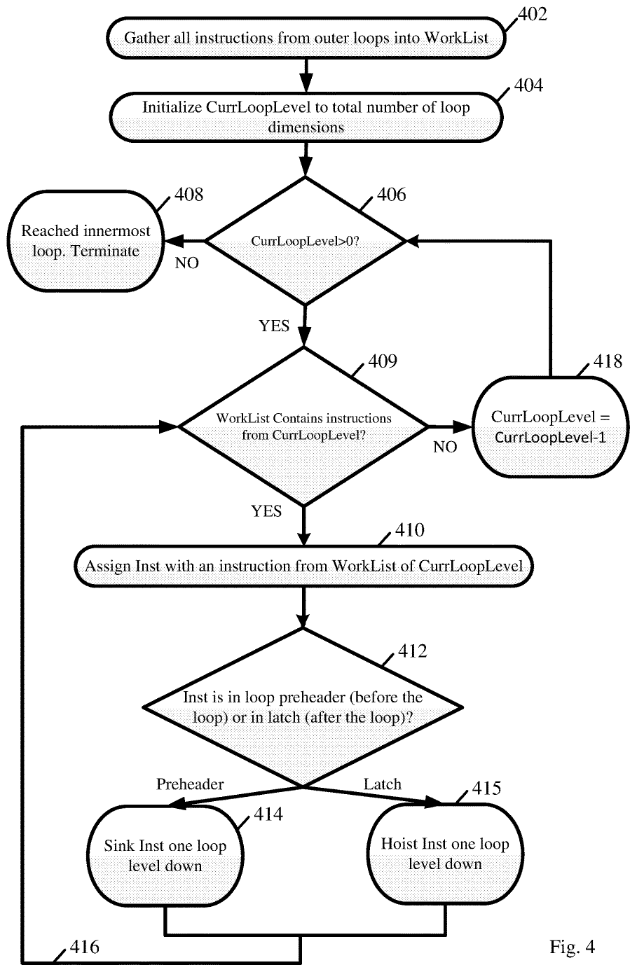

Reference is made to FIG. 4, which schematically illustrates a method of compiling code for a processor. For example, one or more operations of the method of FIG. 4 may be performed by a system, e.g., system 100 (FIG. 1); a device, e.g., device 102 (FIG. 1); a server, e.g., server 170 (FIG. 1); and/or a compiler, e.g., compiler 160 (FIG. 1), and/or compiler 200 (FIG. 2).

In some demonstrative aspects, as indicated at block 402, the method may include identifying instructions of outer loops of a loop nest. For example, compiler 160 (FIG. 1) may generate a list (WorkList) of the one or more identified instructions of the outer loops of a loop nest based on source code 112 (FIG. 1), e.g., as described above.

In some demonstrative aspects, as indicated at block 404, the method may include initializing a currently analyzed loop level (CurrLoopLevel) of the loop nest, e.g., based on a total number of loop dimensions (loop levels) of the loop nest. For example, compiler 160 (FIG. 1) may initialize a currently analyzed loop level of the loop nest to a highest loop level, e.g., corresponding to an outermost loop of the loop nest.

In some demonstrative aspects, as indicated at block 406, the method may include iterating over the loop levels of the loop nest, e.g., from the highest loop level to the lowest loop level, for example, until the currently analyzed loop level includes a loop level of the inner most loop of the loop nest. For example, compiler 160 (FIG. 1) may iterate over the loop levels of the loop nest.

In some demonstrative aspects, as indicated at block 408, the method may include determining that loop-nesting iterations are to be terminated, for example, when the currently analyzed loop level includes the level of the innermost loop of the loop nest. For example, compiler 160 (FIG. 1) may terminate loop-nesting iterations to create the perfect loop nest of Example 13, for example, when the loop level includes the inner most loop of the loop nest of Example 10, e.g., as described above.

In some demonstrative aspects, as indicated at block 409, the method may include determining whether or not the currently analyzed loop includes an outer instruction, which is to be moved into an inner loop. For example, compiler 160 (FIG. 1) may determine whether or not the currently analyzed loop includes an outer instruction from the WorkList, e.g., as described above.

In some demonstrative aspects, as indicated at block 410, the method may include assigning one or more identified outer instructions of the currently analyzed loop to be moved into the inner loop. For example, compiler 160 (FIG. 1) may assign the one or more identified outer instructions in the WorkList to be moved into the inner loop, e.g., as described above.

In some demonstrative aspects, as indicated at block 412, the method may include determining whether an identified outer instruction includes a preheader instruction or a latch instruction. For example, compiler 160 (FIG. 1) may determine whether the identified outer instruction includes a preheader instruction or a latch instruction, e.g., as described above.

In some demonstrative aspects, as indicated at block 414, the method may include sinking a preheader instruction into an inner loop having a loop level, which is one level below the loop level of the outer loop. For example, compiler 160 (FIG. 1) may sink the preheader instruction into the inner loop, e.g., as described above.

In some demonstrative aspects, as indicated at block 415, the method may include hoisting a latch instruction into an inner loop having a loop level, which is one level below the loop level of the outer loop. For example, compiler 160 (FIG. 1) may hoist the latch instruction into the inner loop, e.g., as described above.

In some demonstrative aspects, as indicated by arrow 416, the method may include returning to repeat the operations beginning at block 409 with respect to a next identified outer instruction of the outer loop, e.g., until reaching a last outer instruction of the outer loop.

In some demonstrative aspects, as indicated at block 418, the method may include returning to repeat the operations beginning at block 406 for a next outer loop, which is one level below the loop level of the currently analyzed outer loop, e.g., until reaching the innermost loop of the loop nest.

In some demonstrative aspects, one or more operations of the method of FIG. 4 may be implemented to configure select instructions at a loop level, e.g., each loop level, for example, based on start/end-predicates for the loop level.

For example, these select instructions may be optimized, for example, by noticing how sunk values may be used.

For example, if the sunk values are not being used in one or more loop levels, one or more selections/predications may be optimized away.

In some demonstrative aspects, a compiler, e.g., compiler 160 (FIG. 1), may be configured to compile code of a loop, for example, code of a loop based on source code 112 (FIG. 1), for example, according to one or more operations of a loop compilation algorithm, e.g., as described below.

In some demonstrative aspects, the loop compilation algorithm may be configured with respect to code utilizing Phi instructions, for example, according to an LLVM-based compilation scheme, e.g., as described below. For example, a Phi instruction may be utilized to implement a φ node in a Static Single Assignment (SSA) graph representing a function, e.g., according to the LLVM-based compilation scheme. In other aspect, the loop compilation algorithm may be configured with respect to code utilizing any other additional or alternative type of instructions and/or according to any other suitable compilation scheme.

In some demonstrative aspects, the loop compilation algorithm may include one or more of the following operations:

Algorithm (1)

| | |
|---|---|
| 1. | Gather initial instructions for sink/hoist: |
| • | Initialize the list to all store instructions in outer-most loop |
| • | Add all stores operands to the list, for example, while discluding address |
| | computation for AGUifiable stores |
| • | Remove all Phi instructions (Phis) from the list, e.g., since they will be |
| | sunk as users (through backedge) |
| 2. | For each loop level, starting from outer-most loop until the inner-most |

loop:

| | |
|---|---|
| • | For each preheader instruction sink (2.1) the instruction. If the instruction |
| | also requires predication (2.2) add it to predication list |
| • | For each latch instruction hoist (2.3) the instruction. If the instruction also |
| | requires predication (2.4) add it to predication list |
| • | Add predication (2.5) for each instruction in the predication list |

2.1 - Sinking an instruction
Sinking an instruction may be done by moving it from current loop level
preheader into the next inner loop level preheader.
If the instruction is a store we may convert it into a masked_store, e.g., based
on a FirstIter predicate. If the instruction also feeds a PHI, a FirstIter selection
(2.6) may be added based on the level of the sunk instruction.
2.2 - Sink requires predication
A sunk instruction requires predication, for example, if its value is used (and
later stored) in a latch. This is because we may need to ensure its value
remains valid (and not overridden) until the latch. The operation of adding
predication for the sunk instruction is also referred to as ‘rotation’.
2.3 - Hoisting an instruction
Hoisting an instruction may be done by moving it from the current loop level
latch into the next inner loop level latch.
If the instruction is a store we may convert it into a masked_store, for
example, based on a LastIter predicate
2.4 - Hoist requires predication
A hoisted instruction may require predication, for example, if it feeds a PHI.
Such instruction may not be hoisted as is, and may, e.g., should, be ‘executed’
only in the latch.
2.5 - Adding predication
Adding predication for a sunk instruction (or ‘rotating it’) may be done, for
example, by adding a FirstIter selection (2.6) between the instruction value
and its value from previous iteration.
Adding predication for a hoisted instruction may be done by adding a LastIter
selection (2.6) between the instruction value and the PHI it feeds.
2.6 - FirstIter/LastIter selection
A FirstIter selection may be a selection predicated on whether the loop just
entered a certain loop level.
A LastIter selection may be a selection predicated on whether the loop just
exited a certain loop level.
There are several ways of generating such predicates, e.g.,:
• Generating the IV and comparing it with initial/last values, e.g., as described
above
• Using hardware support, for example MaskReset component, e.g., as
described above

In one example, one or more, e.g., some or all, of the operations of Algorithm 1 may be applied to the following loop:

```
L2:
%init.val = 5
  L1:
  %sum = phi(%init.val, %sum.inc)
  L0:
  ...
  %sum.inc = %sum + 1
store %sum.inc
```

### Example (14)

In one example, the loop of Example 14 may be collapsed with induction generation, e.g., by applying a sink/hoist at L2. For example, when sinking (2.1) % init.val, it may be noted that it feeds a Phi in L1. Accordingly, a FirstIter selection may be added.

For example, the store operation may be masked when hoisting it (2.3).

For example, the following loop nest may be determined, e.g., after the L2 sink/hoist:

```
L2:
  L1:
  %sum = phi(undef, %sum.inc)
  %mask1 = cmp %induction.L1 == 0 // L1_start
  %select1 = select(%mask1, %init.val, %sum)
  L0:
  ...
  %sum.inc = %select1 + 1
  %store_mask = cmp %induction.L2 == %count.L2 // L2_end
  masked_store %store_mask, %sum.inc
```

### Example (15)

For example, when sinking (2.1) L1, it may be identified that % select1 feeds an instruction in the latch (% sum.inc), so it may be added to the predication list, e.g., according to (2.2).

For example, when hoisting (2.3) L1 it may be identified that % sum.inc feeds a PHI (% sum), so it may be added to the predication list, according to (2.4).

For example, the following perfect loop may be determined, e.g., after L1 sink/hoist:

```
L2:
  L1:
  L0:
  %sum = phi(undef, %sum.inc)
  %mask1 = cmp %induction.L1 == 0 // L1_start
  %select1 = select(%mask1, %init.val, %sum)
  ...
  %sum.inc = %select1 + 1
  %store_mask = cmp %induction.L2 == %count.L2 // L2_end
  masked_store %store_mask, %sum.inc
```

### Example (16)

For example, as per the loop of Example 16, all instructions may be in the inner-most loop.

For example, predication may be added, for example, for two instructions, e.g., as follows:

```
L2:
  L1:
  L0:
  %sum = phi(undef, %sum.inc)
  %prev.select2 = phi(undef, %select2)
  %prev.select3 = phi(undef, %select3)
  %mask1 = cmp %induction.L1 == 0 // L1_start
  %select1 = select(%mask1, %init.val, %sum)
  %mask2 = cmp %induction.L0 == 0 // L0_start
  %select2 = select(%mask2, %select1, %prev.select2)
  ...
  %sum.inc = %select2 + 1
  %mask3 = cmp %induction.L1 == %count.L1 // L1_end
  %select3 = select(%mask3, %sum.inc, %prev.select3)
  %store_mask = cmp %induction.L2 == %count.L2 // L2_end
  masked_store %store_mask, %select3
```

### Example (17)

For example, inductions may be generated, e.g., as follows:

%induction.L1.init = phi(undef, %induction.L1)
%induction.L2.init = phi(undef, %induction.L2)
%induction.L3.init = phi(undef, %induction.L3)
%add1 = add %induction.L1.init, 1
%pred.L1 = cmp %induction.L1.init == %count.L1
%induction.L1 = select %pred.L1, 0, %add1
%add2 = add %induction.L2.init, 1
%induction.L2.init2 = select %pred.L1, %add2, %induction.L2.init
%pred.L2 = cmp %induction.L2.init2 == %count.L2
%induction.L2 = select %pred.L2, 0, %induction.L2.init2
%add3 = add %induction.L3.init, 1
%induction.L3.init3 = select %pred.L2, %add3, %induction.L3.init
%pred.L3 = cmp %induction.L3.init3 == %count.L3
%induction.L3 = select %pred.L3, 0, %induction.L3.init2

### Example (18)

In one example, the loop of Example 17 may be collapsed, for example, with a mask-reset mechanism, e.g., as described below.

For example, a sink/hoist may be implemented at L2. For example, when sinking (2.1) % init.val it may be identified that it feeds a Phi in L1, so a FirstIter MaskReset selection may be added.

For example, the store operation may be masked, e.g., when hoisting it (2.3).

For example, after the L2 sink/hoist the following loop may be reached:

```
L2:
  L1:
  %sum = phi(undef, %sum.inc)
  %mask1 = mask.reset // L1_start
  %select1 = select(%mask1, %init.val, %sum)
  L0:
  ...
  %sum.inc = %select1 + 1
  %store_mask = mask.reset // L2_end
  masked_store %store_mask, %sum.inc
```

### Example (19)

For example, when sinking (2.1) L1 it may be identified that % select1 feeds an instruction in the latch (% sum.inc), so it may be added to the predication list, e.g., according to (2.2).

For example, when hoisting (2.3) L1 it may be identified that % sum.inc feeds a PHI (% sum), so it may be added to the predication list, according to (2.4).

For example, the following perfect loop may be determined, e.g., after the L1 sink/hoist:

```
L2:
  L1:
  L0:
  %sum = phi(undef, %sum.inc)
  %mask1 = mask.reset // L1_start
  %select1 = select(%mask1, %init.val, %sum)
  ...
  %sum.inc = %select1 + 1
  %store_mask = mask.reset // L2_end
  masked_store %store_mask, %sum.inc
```

### Example (20)

For example, all instructions in the loop of Example 20 may be in the inner-most loop.

For example, predication may be added for the two instructions, e.g., as follows:

```
L2:
  L1:
  L0:
  %sum = phi(undef, %sum.inc)
  %prev.select2 = phi(undef, %select2)
  %prev.select3 = phi(undef, %select3)
  %mask1 = mask.reset // L1_start
  %select1 = select(%mask1, %init.val, %sum)
  %mask2 = mask.reset // L0_start
  %select2 = select(%mask2, %select1, %prev.select2)
  ...
  %sum.inc = %select2 + 1
  %mask3 = mask.reset // L1_end
  %select3 = select(%mask3, %sum.inc, %prev.select3)
  %store_mask = mask.reset // L2_end
  masked_store %store_mask, %select3
```

### Example (21)

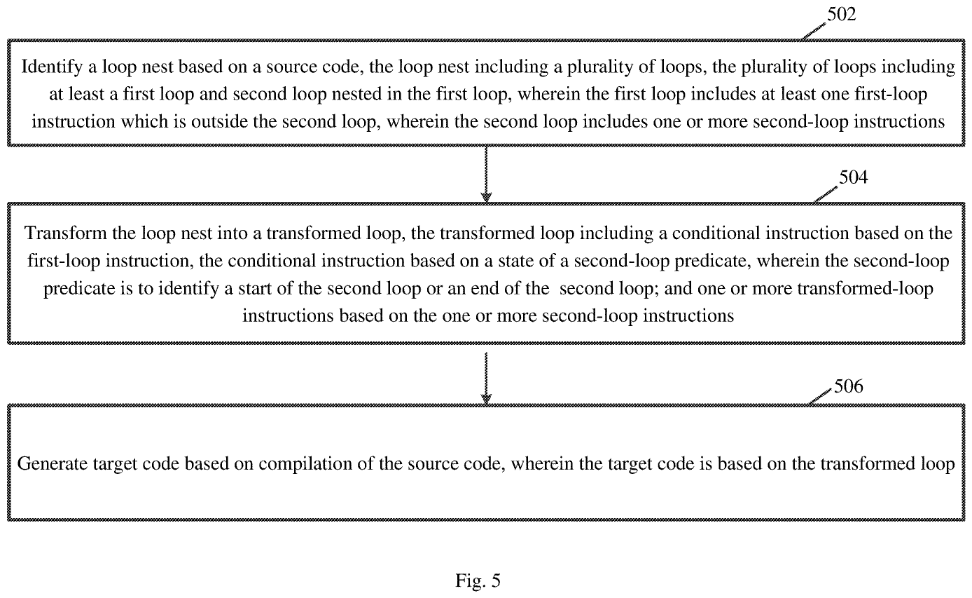

Reference is made to FIG. 5, which schematically illustrates a method of compiling code for a processor. For example, one or more operations of the method of FIG. 5 may be performed by a system, e.g., system 100 (FIG. 1); a device, e.g., device 102 (FIG. 1); a server, e.g., server 170 (FIG. 1); and/or a compiler, e.g., compiler 160 (FIG. 1), and/or compiler 200 (FIG. 2).

In some demonstrative aspects, as indicated at block 502, the method may include identifying a loop nest based on a source code, the loop nest including a plurality of loops, the plurality of loops including at least a first loop and second loop nested in the first loop. For example, the first loop may include at least one first-loop instruction which is outside the second loop, and the second loop may include one or more second-loop instructions. For example, compiler 160 (FIG. 1) may be configured to identify the loop nest, for example, based on the source code 112 (FIG. 1), e.g., as descried above.

In some demonstrative aspects, as indicated at block 504, the method may include transforming the loop nest into a transformed loop. For example, the transformed loop may include a conditional instruction based on the first-loop instruction. For example, the conditional instruction may be based on a state of a second-loop predicate. For example, the second-loop predicate may identify a start of the second loop or an end of the second loop. For example, the transformed loop may include one or more transformed-loop instructions based on the one or more second-loop instructions. For example, compiler 160 (FIG. 1) may be configured to transform the loop nest into the transformed loop, e.g., as descried above.

In some demonstrative aspects, as indicated at block 506, the method may include generating target code based on compilation of the source code, wherein the target code is based on the transformed loop. For example, compiler 160 (FIG. 1) may be configured to generate target code 115 (FIG. 1) based on the transformed loop, e.g., as descried above.

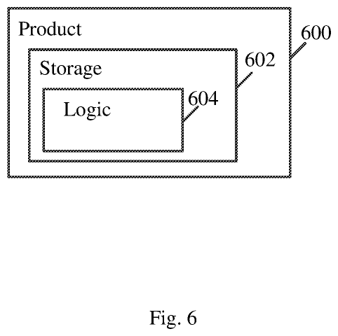

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), server 170 (FIG. 1), and/or compiler 160 (FIG. 1), to cause device 102 (FIG. 1), server 170 (FIG. 1), and/or compiler 160 (FIG. 1) to perform, trigger and/or implement one or more operations and/or functionalities, and/or to perform, trigger and/or implement one or more operations and/or functionalities described with reference to the FIGS. 1-5, and/or one or more operations described herein. The phrases “non-transitory machine-readable medium” and “computer-readable non-transitory storage media” may be directed to include all computer-readable media, with the sole exception being a transitory propagating signal.

In some demonstrative aspects, product 600 and/or machine-readable storage media 602 may include one or more types of computer-readable storage media capable of storing data, including volatile memory, non-volatile memory, removable or non-removable memory, erasable or non-erasable memory, writeable or re-writeable memory, and the like. For example, machine-readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.
Example 1 includes a product comprising one or more tangible computer-readable non-transitory storage media comprising computer-executable instructions operable to, when executed by at least one processor, enable the at least one processor to cause a compiler to identify a loop nest based on a source code, the loop nest comprising a plurality of loops, the plurality of loops comprising at least a first loop and second loop nested in the first loop, wherein the first loop comprises at least one first-loop instruction which is outside the second loop, wherein the second loop comprises one or more second-loop instructions; transform the loop nest into a transformed loop, the transformed loop comprising a conditional instruction based on the first-loop instruction, the conditional instruction based on a state of a second-loop predicate, wherein the second-loop predicate is to identify a start of the second loop or an end of the second loop; and one or more transformed-loop instructions based on the one or more second-loop instructions; and generate target code based on compilation of the source code, wherein the target code is based on the transformed loop.
Example 2 includes the subject matter of Example 1, and optionally, wherein the transformed loop comprises at least one second-loop predicate instruction configured to identify the state of the second-loop predicate.
Example 3 includes the subject matter of Example 2, and optionally, wherein the second-loop predicate instruction comprises an Induction Variable (IV) independent (IV-independent) instruction, which is independent of an IV of the second loop and an IV of the first loop.
Example 4 includes the subject matter of Example 2 or 3, and optionally, wherein the target code comprises one or more Address Generation Unit (AGU) instructions to configure an AGU of a target processor to execute the target code, the AGU instructions configured to cause the AGU to set an AGU mask to be true based on the start of the second loop or the end of the second loop, wherein the second-loop predicate instruction is configured to retrieve the AGU mask, wherein the conditional instruction is based on the AGU mask.
Example 5 includes the subject matter of Example 2, and optionally, wherein the at least one second-loop predicate instruction comprises at least one Induction Variable (IV) based (IV-based) instruction based on an IV of the second loop.
Example 6 includes the subject matter of Example 5, and optionally, wherein the at least one IV-based instruction is separate from the conditional instruction.
Example 7 includes the subject matter of Example 5, and optionally, wherein the conditional instruction comprises the at least one IV-based instruction.
Example 8 includes the subject matter of any one of Examples 1-7, and optionally, wherein the plurality of loops comprises a third loop nested in the first loop, the second loop is nested in the third loop, the first-loop instruction is outside the third loop, wherein the conditional instruction is based on the state of the second-loop predicate and on a state of a third-loop predicate, wherein the third-loop predicate is to identify a start of the third loop or an end of the third loop.
Example 9 includes the subject matter of Example 8, and optionally, wherein the transformed loop comprises at least one third-loop predicate instruction configured to identify the state of the third-loop predicate.
Example 10 includes the subject matter of Example 8 or 9, and optionally, wherein the third loop comprises a third-loop instruction which is outside the second loop, wherein the transformed loop comprises an other conditional instruction based on the third-loop instruction, wherein the other conditional instruction is based on a state of a particular predicate to identify the start of the second loop or the end of the second loop.
Example 11 includes the subject matter of Example 10, and optionally, wherein the instructions, when executed, cause the compiler to configure the second-loop predicate as the particular predicate, based on a determination that the first-loop instruction and the third-loop instruction are either both pre-header instructions or both latch instructions relative to the second loop.
Example 12 includes the subject matter of Example 10, and optionally, wherein the instructions, when executed, cause the compiler to configure a first predicate of the second-loop predicate or the particular predicate as a loop-start predicate to identify the start of the second loop, and to configure a second predicate of the second-loop predicate or the particular predicate as a loop-end predicate to identify the end of the second loop, based on a determination that a first instruction of the first-loop instruction or the third-loop instruction is a pre-header instruction relative to the second loop and that a second instruction of the first-loop instruction or the third-loop instruction is a latch instruction relative to the second loop.
Example 13 includes the subject matter of any one of Examples 1-12, and optionally, wherein the plurality of loops are nested in a plurality of nest levels, wherein the plurality of nest levels comprises one or more intermediate nest levels between a first nest level comprising the first loop and a second nest level comprising the second loop, wherein the conditional instruction is based on the state of the second-loop predicate and on states of one or more intermediate loop predicates corresponding to the one or more intermediate nest levels, respectively.
Example 14 includes the subject matter of Example 13, and optionally, wherein the second nest level is an innermost nest level of the plurality of nest levels.
Example 15 includes the subject matter of any one of Examples 1-14, and optionally, wherein the at least one first-loop instruction comprises a pre-header instruction to be performed before a first iteration of the second loop, wherein the second-loop predicate comprises a loop-start predicate, which is to identify the start of the second loop.
Example 16 includes the subject matter of Example 15, and optionally, wherein the conditional instruction is before all of the one or more transformed-loop instructions based on the one or more second-loop instructions.
Example 17 includes the subject matter of any one of Examples 1-16, and optionally, wherein the at least one first-loop instruction comprises a latch instruction to be performed after a last iteration of the second loop, wherein the second-loop predicate comprises a loop-end predicate, which is to identify the end of the second loop.
Example 18 includes the subject matter of Example 17, and optionally, wherein the conditional instruction is after all of the one or more transformed-loop instructions based on the one or more second-loop instructions.
Example 19 includes the subject matter of any one of Examples 1-18, and optionally, wherein the transformed loop comprises a perfect flat loop, in which all compute operations of the loop nest are implemented in an inner-most loop.
Example 20 includes the subject matter of any one of Examples 1-19, and optionally, wherein the transformed loop comprises a fully collapsed loop comprising only a single-basic-block loop based on the plurality of loops.
Example 21 includes the subject matter of any one of Examples 1-20, and optionally, wherein the target code comprises one or more Address Generation Unit (AGU) instructions to configure an AGU of a target processor to execute the target code, the AGU instructions configured to cause the AGU to set an AGU mask to be true based on the start of the second loop or the end of the second loop, wherein the conditional instruction is based on the AGU mask.
Example 22 includes the subject matter of any one of Examples 1-21, and optionally, wherein the first-loop instruction comprises a first-loop operation on a variable, wherein the conditional instruction comprises a select operation to select between a first operation on the variable and a second operation on the variable, wherein the first operation on the variable is based on the first-loop operation on the variable.
Example 23 includes the subject matter of Example 22, and optionally, wherein the second operation on the variable is based on a second-loop operation on the variable in the second loop.
Example 24 includes the subject matter of any one of Examples 1-23, and optionally, wherein the conditional instruction comprises a select operation to select between a first value and a second value based on the state of the second-loop predicate.
Example 25 includes the subject matter of any one of Examples 1-24, and optionally, wherein the one or more transformed-loop instructions comprise at least one of the one or more second-loop instructions.
Example 26 includes the subject matter of any one of Examples 1-25, and optionally, wherein the source code comprises Open Computing Language (OpenCL) code.
Example 27 includes the subject matter of any one of Examples 1-26, and optionally, wherein the computer-executable instructions, when executed, cause the compiler to compile the source code into the target code according to a Low Level Virtual Machine (LLVM) based (LLVM-based) compilation scheme.
Example 28 includes the subject matter of any one of Examples 1-27, and optionally, wherein the target code is configured for execution by a Very Long Instruction Word (VLIW) Single Instruction/Multiple Data (SIMD) target processor.
Example 29 includes the subject matter of any one of Examples 1-28, and optionally, wherein the target code is configured for execution by a target vector processor.
Example 30 includes a compiler configured to perform any of the described operations of any of Examples 1-29.
Example 31 includes a computing device configured to perform any of the described operations of any of Examples 1-29.
Example 32 includes a computing system comprising at least one memory to store instructions; and at least one processor to retrieve instructions from the memory and execute the instructions to cause the computing system to perform any of the described operations of any of Examples 1-29.
Example 33 includes a computing system comprising a compiler to generate target code according to any of the described operations of any of Examples 1-29, and a processor to execute the target code.
Example 34 comprises an apparatus comprising means for executing any of the described operations of any of Examples 1-29.
Example 35 comprises an apparatus comprising: a memory interface; and processing circuitry configured to: perform any of the described operations of any of Examples 1-29.
Example 36 comprises a method comprising any of the described operations of any of Examples 1-29.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1.-32. (canceled)

33. A product comprising one or more tangible computer-readable non-transitory storage media comprising computer-executable instructions operable to, when executed by at least one processor, enable the at least one processor to cause a compiler to:
identify a loop nest based on a source code, the loop nest comprising a plurality of loops, the plurality of loops comprising at least a first loop and second loop nested in the first loop, wherein the first loop comprises at least one first-loop instruction which is outside the second loop, wherein the second loop comprises one or more second-loop instructions;
transform the loop nest into a transformed loop, the transformed loop comprising:
a conditional instruction based on the first-loop instruction, the conditional instruction based on a state of a second-loop predicate, wherein the second-loop predicate is to identify a start of the second loop or an end of the second loop; and
one or more transformed-loop instructions based on the one or more second-loop instructions; and
generate target code based on compilation of the source code, wherein the target code is based on the transformed loop.

34. The product of claim 33, wherein the transformed loop comprises at least one second-loop predicate instruction configured to identify the state of the second-loop predicate.

35. The product of claim 34, wherein the second-loop predicate instruction comprises an Induction Variable (IV) independent (IV-independent) instruction, which is independent of an IV of the second loop and an IV of the first loop.

36. The product of claim 34, wherein the target code comprises one or more Address Generation Unit (AGU) instructions to configure an AGU of a target processor to execute the target code, the AGU instructions configured to cause the AGU to set an AGU mask to be true based on the start of the second loop or the end of the second loop, wherein the second-loop predicate instruction is configured to retrieve the AGU mask, wherein the conditional instruction is based on the AGU mask.

37. The product of claim 34, wherein the at least one second-loop predicate instruction comprises at least one Induction Variable (IV) based (IV-based) instruction based on an IV of the second loop.

38. The product of claim 33, wherein the plurality of loops comprises a third loop nested in the first loop, the second loop is nested in the third loop, the first-loop instruction is outside the third loop, wherein the conditional instruction is based on the state of the second-loop predicate and on a state of a third-loop predicate, wherein the third-loop predicate is to identify a start of the third loop or an end of the third loop.

39. The product of claim 38, wherein the transformed loop comprises at least one third-loop predicate instruction configured to identify the state of the third-loop predicate.

40. The product of claim 38, wherein the third loop comprises a third-loop instruction which is outside the second loop, wherein the transformed loop comprises an other conditional instruction based on the third-loop instruction, wherein the other conditional instruction is based on a state of a particular predicate to identify the start of the second loop or the end of the second loop.

41. The product of claim 40, wherein the instructions, when executed, cause the compiler to configure the second-loop predicate as the particular predicate, based on a determination that the first-loop instruction and the third-loop instruction are either both pre-header instructions or both latch instructions relative to the second loop.

42. The product of claim 40, wherein the instructions, when executed, cause the compiler to configure a first predicate of the second-loop predicate or the particular predicate as a loop-start predicate to identify the start of the second loop, and to configure a second predicate of the second-loop predicate or the particular predicate as a loop-end predicate to identify the end of the second loop, based on a determination that a first instruction of the first-loop instruction or the third-loop instruction is a pre-header instruction relative to the second loop and that a second instruction of the first-loop instruction or the third-loop instruction is a latch instruction relative to the second loop.

43. The product of claim 33, wherein the plurality of loops are nested in a plurality of nest levels, wherein the plurality of nest levels comprises one or more intermediate nest levels between a first nest level comprising the first loop and a second nest level comprising the second loop, wherein the conditional instruction is based on the state of the second-loop predicate and on states of one or more intermediate loop predicates corresponding to the one or more intermediate nest levels, respectively.

44. The product of claim 43, wherein the second nest level is an innermost nest level of the plurality of nest levels.

45. The product of claim 33, wherein the at least one first-loop instruction comprises a pre-header instruction to be performed before a first iteration of the second loop, wherein the second-loop predicate comprises a loop-start predicate, which is to identify the start of the second loop.

46. The product of claim 45, wherein the conditional instruction is before all of the one or more transformed-loop instructions based on the one or more second-loop instructions.

47. The product of claim 33, wherein the at least one first-loop instruction comprises a latch instruction to be performed after a last iteration of the second loop, wherein the second-loop predicate comprises a loop-end predicate, which is to identify the end of the second loop.

48. The product of claim 47, wherein the conditional instruction is after all of the one or more transformed-loop instructions based on the one or more second-loop instructions.

49. The product of claim 33, wherein the transformed loop comprises a perfect flat loop, in which all compute operations of the loop nest are implemented in an inner-most loop.

50. The product of claim 33, wherein the transformed loop comprises a fully collapsed loop comprising only a single-basic-block loop based on the plurality of loops.

51. The product of claim 33, wherein the target code comprises one or more Address Generation Unit (AGU) instructions to configure an AGU of a target processor to execute the target code, the AGU instructions configured to cause the AGU to set an AGU mask to be true based on the start of the second loop or the end of the second loop, wherein the conditional instruction is based on the AGU mask.

52. The product of claim 33, wherein the first-loop instruction comprises a first-loop operation on a variable, wherein the conditional instruction comprises a select operation to select between a first operation on the variable and a second operation on the variable, wherein the first operation on the variable is based on the first-loop operation on the variable.

53. The product of claim 33, wherein the conditional instruction comprises a select operation to select between a first value and a second value based on the state of the second-loop predicate.

54. A computing system comprising:
at least one memory to store instructions; and
at least one processor to retrieve the instructions from the memory and to execute the instructions to cause the computing system to:
identify a loop nest based on a source code, the loop nest comprising a plurality of loops, the plurality of loops comprising at least a first loop and second loop nested in the first loop, wherein the first loop comprises at least one first-loop instruction which is outside the second loop, wherein the second loop comprises one or more second-loop instructions;
transform the loop nest into a transformed loop, the transformed loop comprising:
a conditional instruction based on the first-loop instruction, the conditional instruction based on a state of a second-loop predicate, wherein the second-loop predicate is to identify a start of the second loop or an end of the second loop; and
one or more transformed-loop instructions based on the one or more second-loop instructions; and
generate target code based on compilation of the source code, wherein the target code is based on the transformed loop.

55. The computing system of claim 54 comprising a target vector processor to execute the target code.

56. A method comprising:
identify a loop nest based on a source code, the loop nest comprising a plurality of loops, the plurality of loops comprising at least a first loop and second loop nested in the first loop, wherein the first loop comprises at least one first-loop instruction which is outside the second loop, wherein the second loop comprises one or more second-loop instructions;
transform the loop nest into a transformed loop, the transformed loop comprising:
a conditional instruction based on the first-loop instruction, the conditional instruction based on a state of a second-loop predicate, wherein the second-loop predicate is to identify a start of the second loop or an end of the second loop; and
one or more transformed-loop instructions based on the one or more second-loop instructions; and
generate target code based on compilation of the source code, wherein the target code is based on the transformed loop.

57. The method of claim 56, wherein the transformed loop comprises at least one second-loop predicate instruction configured to identify the state of the second-loop predicate.
